(19) United States
(12) Patent Application Publication
(10) Pub. No.: US 2008/0287100 A1
(43) Pub. Date: Nov. 20, 2008

(54) Mobile account access through a data processing system

(75) Inventors: Thekku Veethil Satheesh, Bangalore (IN); Anissa Varnell, Bangalore (IN); Vishal Gupta, Bangalore (IN)

Correspondence Address: Raj Abhyanker, LLP;c/o Intellevate, P.O. Box 52050, Minneapolis, MN, 55402, US

(73) Assignee: AOL LLC

(21) Appl. No.: 11/804,628

(22) Filed: May 18, 2007

(51) Int. Cl. H04M 1/66; H04M 1/00

(52) U.S. Cl. 455/411; 455/556.1

(57) ABSTRACT

A system, method and apparatus of mobile account access through a data processing system are disclosed. In one embodiment, a system includes a personal computer coupled to a network, a mobile service provider module of a mobile network to provide access to a mobile account, to verify that the mobile account is authorized by a mobile service provider, and to enable usages of services associated with the mobile account; and a virtual cell module of the personal computer to communicate an identification data of the mobile account to the mobile service provider module to be verified and to provide access to the mobile account through the personal computer. The system may also include a purchasing module of the virtual cell module to request and to download multimedia data from a content provider coupled to the mobile service provider module to display on the virtual cell module.

### FIELD OF TECHNOLOGY

This disclosure relates generally to the technical fields of mobile communication, and in one example embodiment, to a system, method and apparatus of mobile account access through a data processing system.

### BACKGROUND

A mobile device (e.g., a cellular phone, a PDA, a radio) may enable a user to communicate with others through an account with a cellular service provider (e.g., AT&T, Sprint, Nextel, Verizon, AirTel, etc.). The mobile account may contain certain information (e.g., time allotment, subscription plan, prepaid balance, and/or identification). The identification information may be associated with a specific communication device and may be used to recognize and to verify users of the mobile account in a cellular network (e.g., Electronic Serial Number (ESN), Mobile Identification Number (MIN), and/or System Identification Code (SIC), etc.). Thus, the identification information may be used to access the mobile account from an authorized device.

An office (e.g. a mobile switching center (MSC)) may use the identification information to verify the mobile account and/or authenticate the mobile device associated with the mobile account of the user. The office may communicate with a number of databases that store information of mobile accounts. The office may verify the mobile account by referencing a particular database of the number of databases.

By authorizing the user to communicate with the cellular service provider through the cellular network, the user may perform certain functions from the authorized device (e.g., make and/or receive phone calls, and/or send and/or receive voice, text, and/or multimedia (e.g., picture, graphic, and/or video) messages, interact with other users in an application, send and/or receive email, send and/or receive multimedia content, and/or operate an application of the cellular service provider). The mobile account may also enable a usage of enhanced services (e.g., call forwarding, voice services, mobile web, etc.). Regarding each function, the authorized device may contain package a data and transmit it (e.g., through a channel of the cellular network) to another user and/or (e.g., through a control channel and/or setup channel) to the cellular service provider. The channel may be a single frequency, a spectrum of frequencies (e.g., narrowband), and/or a divided time slot of a frequency.

The mobile account may integrate with another device (e.g., not the authorized mobile device) to provide increased and/or enhanced functionality (e.g., integrate with PDAs, MP3 players, Bluetooth-enabled devices, etc.). Integration of the mobile account with another device may be a difficult endeavor because of security risks for the communications (e.g., personal and/or business) of the user and compatibility issues for another device and/or the mobile account. For integrity and/or security reasons, the mobile service provider may not enable access and/or usage of services associated with a valid mobile account without verification of the user of the mobile account, and/or authentication of the mobile device of the mobile account through the identification information. Furthermore, messages sent from and/or to the mobile device may not be organized and/or classified for the benefit of the user of the mobile account.

### SUMMARY

A system, method and apparatus of mobile account access through a data processing system are disclosed. In one aspect, a system includes a server coupled to a network and a plurality of client devices, a mobile service provider module of a mobile network to provide access to a mobile account, to verify that the mobile account is authorized by a mobile service provider, and/or to enable usage of services associated with the mobile account, and a virtual cell module of the server to communicate an identification data of the mobile account to the mobile service provider module to be verified and/or to provide access to the mobile account through the server.

In addition, the system may include a gateway to bridge communications between the network and the mobile network such that the gateway processes the identification data and/or communicates the identification data to the mobile service provider module through the mobile network.

The virtual cell module may communicate voice data between the network and the mobile service provider module, such that the mobile service provider module route the voice data to an intended recipient. In addition, the virtual cell module may engage in a communication session to exchange the voice data with a user, such that the mobile service provider module route the voice data between the virtual cell module and the user.

The virtual cell module may generate an origination message data and communicate the origination message data between the network and the mobile service provider module, such that the mobile service provider module route the origination message data to an intended recipient. In addition, the virtual cell module may process an incoming message data communicated by the mobile service provider module through the network, such that the mobile service provider module route the incoming message data to the virtual cell module of the server. Further, the virtual cell module may engage in the communication session to exchange message data with another user, such that the mobile service provider module route the message data between the virtual cell module and the another user.

Also, the virtual cell module may process a meta-data communicated by the mobile service provider module through the network, such that the mobile service provider module to route the meta-data to the virtual cell module of the server.

The system may further include a purchasing module of the virtual cell module to request and to download multimedia data from a content provider coupled to the mobile service provider module to display on the virtual cell module. The system may also include a group of operation modules to operate within the virtual cell module to perform a number of the services associated with the mobile account.

In another aspect, a method includes emulating a set of services of a mobile account, accessing the mobile account of a user using an identification data associated with the mobile account through a personal computer coupled to a network, and processing a communication data between a device of another user and the personal computer. In addition, the method may include linking the set of services of the mobile account with an interface of an application of the personal computer. The method may include communicating a data of the application through the network to the mobile service provider module to relay to a receiver. The method may further include processing the data by the application relayed from the mobile service provider module to a virtual cell module through the network from a transferor. In addition, the method may include engaging in an interactive application of the mobile account, such that the mobile service provider module communicates and/or to processes the data of the interactive application through the network.

In yet another aspect, an apparatus includes a virtual cell module embedded in a data processing system, a group of operation modules of the virtual cell module, such that each operation module performs a set of services associated with a mobile account, and a graphical user interface of the virtual cell module having a number of session windows such that each session window exchanges data with a user, a number of input consoles, and/or the group of operation modules linked to the graphical user interface.

In addition, the apparatus may include a network coupled to the data processing system to securely communicate the data transacted to the mobile account through the data processing system, such that the data processing system and a mobile service provider module communicate with each other using the mobile account. In addition, the apparatus may include a number of applications of the data processing system to link and/or to interoperate with the group of operation modules of the virtual cell module.

The apparatus may further include a headset apparatus coupled to the data processing system to input a voice data to the graphical user interface of the virtual cell module. The apparatus may also include a purchasing module to communicate an order of a media content and/or a mobile service associated with the mobile account to a mobile service provider, such that the media content and/or the mobile service to be provided to the virtual cell module of a user of the mobile account and be debited from the mobile account.

In a further aspect, an apparatus includes a virtual cell module embedded in a personal computer, and a personal message information manager of the virtual cell module to download from a mobile service provider at least one message (e.g., a text message, a SMS message, a video message, an audio message, and/or a multimedia message) disseminating from a mobile account. In addition, the apparatus may include a number of folder structures of the personal message information manager to organize the message based on a classification of the message and/or to archive the message in order to later refer to the message of the mobile account.

The apparatus may further include a set of preferences to enable classification and/or organization of the message into any of the number of folder structures. The apparatus may also include an auto-reply module of the personal message information manager to generate and to communicate a preset message to a sender of any one of the message. The apparatus may further include an interface component of the personal message information manager to process an input (e.g., a textual input, an audio input, a video input, and/or a multimedia input) of a user of the mobile account.

In addition, the interface component may analyze a content of the input of the user of the mobile account and/or to identify a potential error of the input. Moreover, the interface component may suggest a modification (e.g., the modification may include spelling change, grammatical change, semantic change, formatting change, etc.) of the content of the input based on the potential error identified through an analysis of the content of the input.

The apparatus may include an integrity component (e.g., antivirus application, an anti-spam application, anti-spyware application, and/or anti-phishing application, etc.) of the personal message information manager to examine the content of the input and/or to identify virus, trojan, phishing activity, denial of service, worm, adware, malware, spyware, and/or spam. In addition, the integrity component may quarantine and/or remove the virus, the trojan, the phishing activity, the denial of service, the worm, the adware, the malware, the spyware, and/or the spam from the content of the input.

The apparatus may also include a send module to communicate the input between a network and the mobile service provider such that the mobile service provider route the content to an intended recipient. The apparatus may further include a delete module of the personal message information manager to remove any one of the at least one message. Moreover, the apparatus may include a purchasing module of the personal message information manager to communicate an order of media content and/or mobile services to the mobile service provider to be provided to a mobile device of the user of the mobile account. The apparatus may further include a synchronization module of the personal message information manager to update and/or to harmonize an information of the user associated with the mobile device of the mobile account with the personal message information manager.

In a next further aspect, a method includes processing a content communicated to a user of a mobile account and/or a content generated by the user of the mobile account through an interface component of a personal message information manager of a virtual cell module of a personal computer, analyzing the content generated by the user of the mobile account for spelling error, formatting error, grammatical error, and/or semantic error, examining the content communicated to the user of the mobile account in order to identify an unwanted, embedded program that poses a security risk, and communicating the content generated by the user of the mobile account between a network and a mobile service provider such that the mobile service provider communicates the content to an intended recipient of the content generated by the user of the mobile account.

In addition, the method may include identifying virus, trojan, denial of service, adware, malware, and/or phishing program of the content communicated to the user of the mobile account. The method may further include sequestering the virus, the trojan, the denial of service, the adware, the malware, and/or the phishing program from the content communicated to the user of the mobile account. The method may also include removing the virus, the trojan, the denial of service, the adware, the malware, and/or the phishing program from the content communicated to the user of the mobile account.

In yet another next aspect, a method includes processing a message by a personal message information manager of a personal computer sent to a user of a mobile account, classifying the message according to a set of preferences of the user of the mobile account, and determining an appropriate folder structure of the personal message information manager according to the set of preferences of the user. In addition, the method may include automatically deleting the message from a folder structure of messages from blocked users of the personal message information manager. The method may further include automatically deleting the message from the folder structure of SPAM messages of the personal message information manager. The method may also include generating a predefined reply message and communicating the predefined reply message to a sender of the message.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1A is a system view of a virtual cell module of a server communicating with a cellular network and a telephone network through a network, according to one embodiment.

FIG. 1B is a system view of the virtual cell module of a personal computer communicating with the cellular network and the telephone network through the network, according to one embodiment.

FIG. 2 is an exploded view of the virtual cell module of FIGS. 1A-B, according to one embodiment.

FIG. 3 is a graphical interface view of the virtual cell module of FIGS. 1A-B, according to one embodiment.

FIG. 4 is an interface view of the associated application modules of FIGS. 1A-B, according to one embodiment.

FIG. 5 is an interface view of the associated application modules of FIGS. 1A-B, according to one embodiment.

FIG. 6 is a diagrammatic system view of a data processing system in which any of the embodiments disclosed herein may be performed, according to one embodiment.

FIG. 7 is an interaction diagram of the virtual cell module, the enterprise module, and the mobile service provider module of FIGS. 1A-B, according to one embodiment.

FIG. 8A is an interaction diagram of the virtual cell module, the enterprise module, and the mobile service provider module of FIGS. 1A-B, according to one embodiment.

FIG. 8B is a continuation of the interaction diagram of the virtual cell module, the enterprise module, and the mobile service provider module of FIGS. 1A-B, according to one embodiment.

FIG. 9 is an interaction diagram of the virtual cell module, the enterprise module, and the mobile service provider module of FIGS. 1A-B, according to one embodiment.

FIG. 10 is an interaction diagram of the virtual cell module, the enterprise module, and the mobile service provider module of FIG. 1A-B, according to one embodiment.

FIG. 11 is an interaction diagram of the virtual cell module, the enterprise module, and the mobile service provider module of FIGS. 1A-B, according to one embodiment.

FIG. 12 is a packet view of a packet sent from the virtual cell module through the network, according to one embodiment.

FIG. 13A is an interface view of a mobile account and a TXT_MAIL application, according to one embodiment

FIG. 13B is an interface view of the mobile account and the personal message information manager, according to one embodiment.

FIG. 13C is an interface view of the mobile account and the personal message information manager, according to one embodiment.

FIG. 14A is an interface view of the TXT_MAIL application, according to one embodiment.

FIG. 14B is an interface view of the TXT_MAIL application, according to one embodiment.

FIG. 14C is an interface view of the TXT_MAIL application, according to one embodiment.

FIG. 15A is a messaging view of the TXT_MAIL application and a mobile phone, according to one embodiment.

FIG. 15B is a messaging view of the TXT_MAIL application and the mobile phone, according to one embodiment.

FIG. 16 is an interface view of the purchasing module of FIG. 2, according to one embodiment.

FIG. 17 is an interface view of an interactive game of the mobile account, according to one embodiment.

FIG. 18 is an interface view of a content of the mobile account, according to one embodiment.

FIG. 19 is an interface view of the communication session module of FIG. 2, according to one embodiment.

FIG. 20 is a table view of a mobile service provider database, according to one embodiment.

FIG. 21 is a process flow of providing access to a mobile account of a user through the virtual cell module, according to one embodiment.

FIG. 22 is a process flow of analyzing and communicating content associated with a user of a mobile account, according to one embodiment.

FIG. 23 is a process flow of processing a message by the personal message information manager, according to one embodiment.

Other features of the present embodiments will be apparent from the accompanying drawings and from the description that follows.

### DETAILED DESCRIPTION

A system, method and apparatus of mobile account access through a data processing system are disclosed. In the following description, for the purposes of explanation, numerous specific details are set forth in order to provide a thorough understanding of the various embodiments. It will be evident, however to one skilled in the art that various embodiments may be practiced without these specific details.

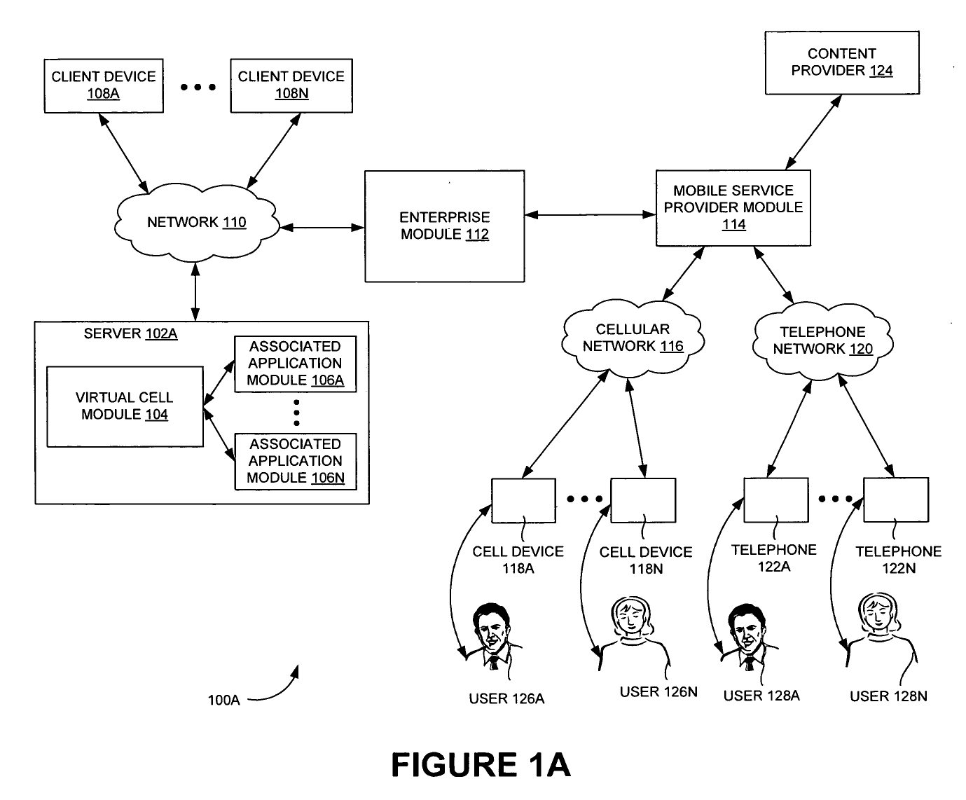

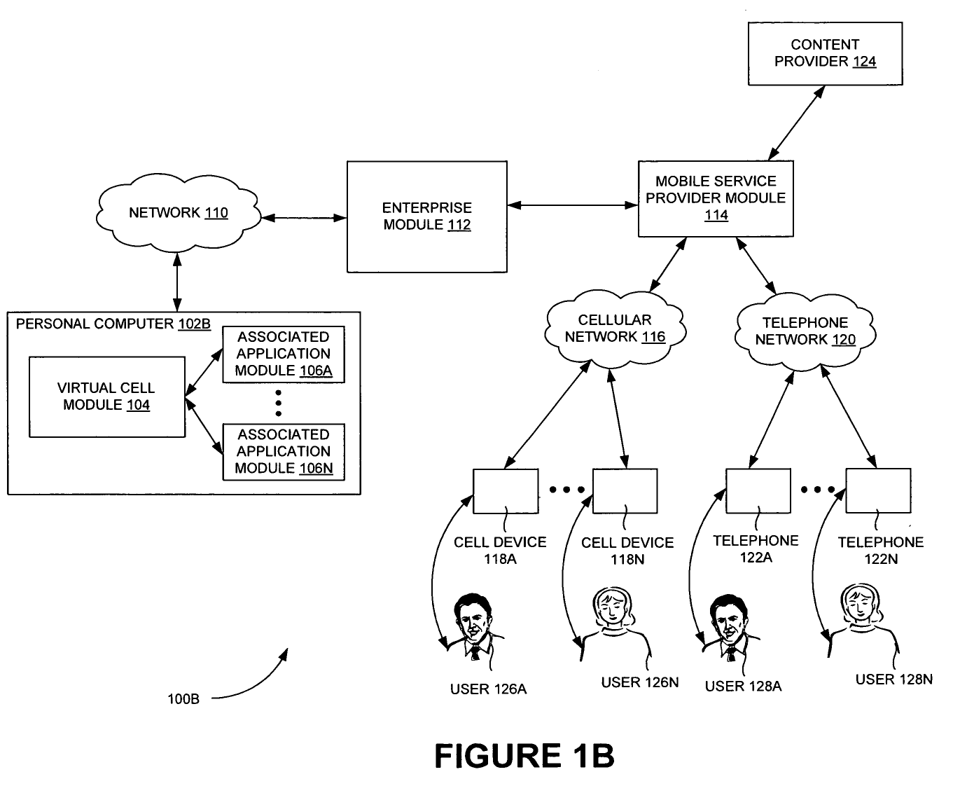

In one embodiment, a system includes a server (e.g., the server 102A of FIG. 1A) coupled to a network (e.g., the network 110 of FIGS. 1A-B and 2) and client devices (e.g., the client devices 108A-N of FIG. 1A), a mobile service provider module (e.g., the mobile service provider module 114 of FIGS. 1A-B) of a mobile network to provide access to a mobile account, to verify that the mobile account is authorized by a mobile service provider, and to enable usage of services associated with the mobile account, and a virtual cell module (e.g., the virtual cell module 104 of FIGS. 1A-B and 2) of the server 102A to communicate an identification data of the mobile account to the mobile service provider module 114 to be verified and to provide access to the mobile account through the server 102A.

In another embodiment, a method includes emulating a set of services of a mobile account, accessing the mobile account of a user using an identification data associated with the mobile account through a personal computer (e.g., the personal computer 102B of FIG. 1B) coupled to a network (e.g., the network 110 of FIGS. 1A-B), and processing a communication data between a device of another user and the personal computer 102B.

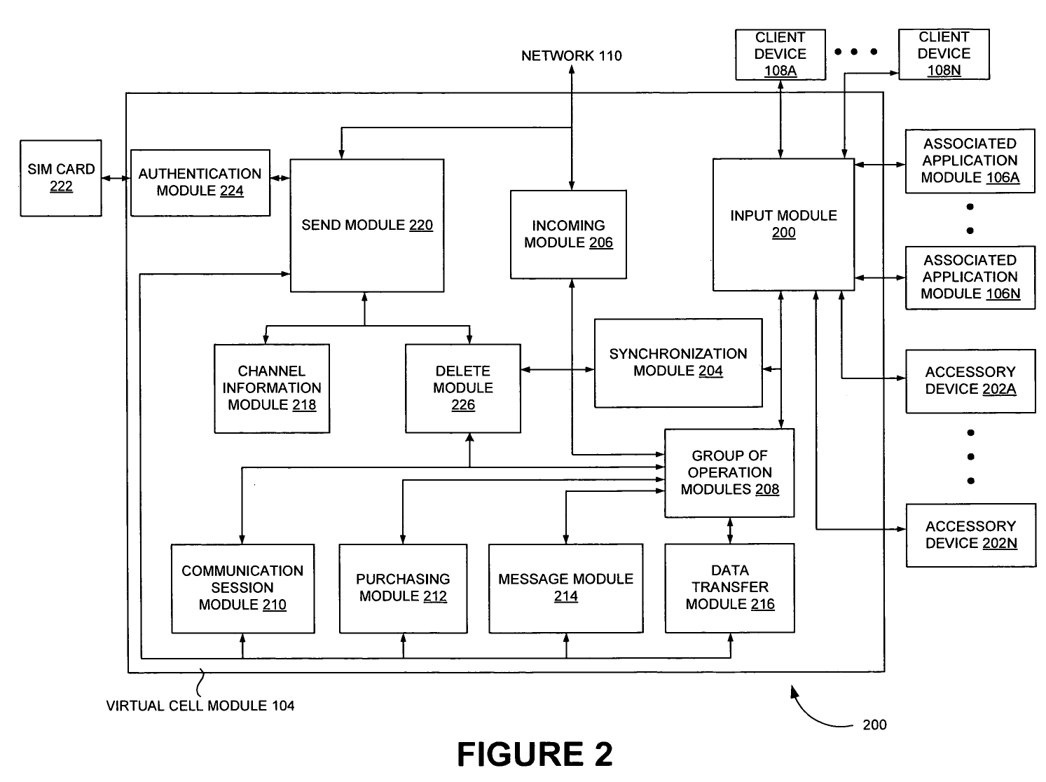

In yet another embodiment, an apparatus includes a virtual cell module (e.g., the virtual cell module 104 of FIGS. 1A-B and 2) embedded in a data processing system (e.g., the server 102A of FIG. 1A and the personal computer 102B of FIG. 1B), a group of operation modules (e.g., the group of operation modules 208 of FIG. 2) of the virtual cell module 104, such that each operation module to perform a set of services associated with a mobile account, and a graphical user interface of the virtual cell module 104 having a number of session windows such that each session window to exchange data with at least one user, a number of input consoles, and the group of operation modules 208 linked to the graphical user interface.

A network (e.g., the network 110 of FIGS. 1A-B) may be coupled to the data processing system (e.g., the server 102A of FIG. 1A and the personal computer 102B of FIG. 1B) to securely communicate the data transacted to the mobile account through the data processing system, such that the data processing system and a mobile service provider module (e.g., the mobile service provider module 114 of FIGS. 1A-B) communicate with each other using the mobile account.

In a further embodiment, an apparatus includes a virtual cell module (e.g., the virtual cell module 104 of FIGS. 1A-B and 2) embedded in a personal computer (e.g., the personal computer 102B of FIG. 1B), and a personal message information manager of the virtual cell module 104 to download from a mobile service provider at least one message disseminating from a mobile account.

In yet a further embodiment, a method includes processing a content communicated to a user (e.g., the users 126A-N and the users 128A-N of FIGS. 1A-B) of a mobile account and/or a content generated by the user of the mobile account through an interface component of a personal message information manager of a virtual cell module (e.g., the virtual cell module 104 of FIGS. 1A-B and 2) of a personal computer (e.g., the personal computer 102B of FIG. 1B), analyzing the content generated by the user of the mobile account for spelling error, formatting error, grammatical error, and/or semantic error, examining the content communicated to the user of the mobile account in order to identify an unwanted, embedded program that poses a security risk, and communicating the content generated by the user of the mobile account between a network (e.g., the network 110 of FIGS. 1A-B) and a mobile service provider such that the mobile service provider to communicate the content to an intended recipient of the content generated by the user of the mobile account.

In a next embodiment, a method includes processing a message by a personal message information manager of a personal computer (e.g., the personal computer 102B of FIG. 1B) sent to a user (e.g., the users 126A-N and the users 128A-N of FIGS. 1A-B) of a mobile account, classifying the message according to a set of preferences of the user of the mobile account, and determining an appropriate folder structure of the personal message information manager according to the set of preferences of the user.

FIG. 1A is a system view of a virtual cell module 104 of a server 102A communicating with a cellular network 116 and a telephone network 120 through a network 110, according to one embodiment. Particularly, FIG. 1A illustrates the server 102A, the virtual cell module 104, associated application modules 106A-N, client devices 108A-N, the network 110, an enterprise module 112, a mobile service provider module 114, the cellular network 116, cell devices 118A-N, the telephone network 120, telephones 122A-N, a content provider 124, users 126A-N of the cell devices 118A-N, and users 128A-N of the telephones 122A-N, according to one embodiment.

The server 102A may be an application server which embeds the virtual cell module 104 and processes a set of instructions associated with the virtual cell module 104 to provide access to a set of services of a mobile account. The server 102A may be coupled to the client devices 108A-N to access inputted data associated with the virtual cell module 104. The virtual cell module 104 may be an application software embedded in the server 102A that links and/or interoperates with the associated application modules 106A-N of the server 102A to communicate data (e.g., identification data, voice data, message data, meta-data, etc.) associated with the mobile account of the users (e.g., the users 126A-N and the users 128A-N) to the mobile service provider module 114 through the network 110. The virtual cell module 104 may also provide access to the mobile account through the client devices 108A-N coupled to the server 102A.

The associated application modules 106A-N may be a web browser, an anti-virus software, a word processor application, a dictionary, a media sharing application and/or a web property application embedded in the server 102A that links and/or interoperates with the virtual cell module 104 of the server 102A for providing the set of services to the user of the mobile account.

The client devices 108A-N may be devices coupled to the server 102A used to input communication data and/or access services (e.g., the services may include communication of voice data, message data, meta-data, organizing of messages, examining of messages, etc.) associated with the virtual cell module 104 of the server 102A. The network 110 may be a configuration of routers, access points, and/or gateways to securely communicate data (e.g., identification data, voice data, meta-data, etc.) packaged into packets using a suite of communication protocols and/or data models from the virtual cell module 104 of the personal computer 102B to the mobile service provider module 114. In addition, the network 110 may be coupled to the server 102A to securely communicate data credited and/or debited to the mobile account through the server 102A, such that the server 102A and the mobile service provider module 114 communicate with each other using the mobile account.

The enterprise module 112 may be a gateway infrastructure (e.g., using a radio frequency) employed to bridge communications between the network 110 coupled to the server 102A and the mobile network (e.g., the cellular network 116 and the telephone network 120) of the mobile service provider module 114. The mobile service provider module 114 may be a structure (e.g., a base station, a base station controller, a mobile switching office, etc.) of a mobile service provider which processes data communicated between a device (e.g., the cell devices 118A-N and the telephones 122A-N of FIG. 1A) of another user and the virtual cell module 104 embedded in the server 102A and/or enables usage of services associated with the mobile account.

The cellular network 116 may be a network that enables accessing the set of services provided by the mobile service provider module 114 to the users 126A-N of the mobile account. The cell devices 118A-N may be a long-range, portable electronic device (e.g., a PDA, a cell phone, etc) used for accessing the set of services (e.g., sending/receiving messages, sending/receiving calls, etc.) associated with the mobile account of the user through the cellular network 116. The telephone network 120 may be a collection of telephones connected through a public wire line to the PSTN (Public Switched Telephone Network) which enables the communication of data (e.g., voice data, message data, meta-data, etc.) between the virtual cell module 104 of the personal computer 102B and the telephones 122A-N of the users 128A-N. The telephones 122A-N may be communication devices used to access the set of services provided by the virtual cell module 104 of the server 102A through the telephone network 120.

The content provider 124 may provide contents (e.g., textual content, audio content, multimedia content, etc.) to the user(s) (e.g., the users 126A-N and the users 128A-N) of the mobile device (e.g., the cell devices 118A-N and the telephones 122A-N) through the mobile service provider module 114.

The users 126A-N may be entities (e.g., patron, business, organization, etc.) associated with the cell devices 118A-N that access the set of services of the virtual cell module 104 embedded in the server 102A. The users 128A-N may be entities (e.g., patron, business, organization, etc.) associated with the telephones 122A-N that access the set of services enabled by the virtual cell module 104 of the server 102A through the mobile service provider module 114.

In the example embodiment illustrated in FIG. 1A, the server 102A having the virtual cell module 104 communicates with the mobile service provider module 114 through the network 110. In addition, the server 102A coupled to the network 110 communicates with the client devices 108A-N. The enterprise module 112 enables communication of data (e.g., voice data, message data, meta-data, etc.) between the network 110 coupled to the server 102A and the mobile service provider module 114. The mobile service provider module 114 communicates directly with the content provider 124 to generate the contents associated with the mobile account.

The users 126A-N associated with the cell devices 118A-N communicates through the cellular network 116 to the mobile service provider module 114. The users 128A-N communicates with the mobile service provider module 114 through the telephone network 120 using the telephones 122A-N as illustrated in the example embodiment of FIG. 1B. The server 102A may be coupled to the network 110 and client devices 108A-N. The mobile service provider module 114 of the mobile network (e.g., the cellular network 116 and the telephone network 120) may provide access to the mobile account, verify that the mobile account is authorized by the mobile service provider and/or enable usage of services (e.g., the services may include communication of voice data, meta-data, message data, examining input provided by the user, etc.) associated with the mobile account.

The virtual cell module 104 of the server 102A may be coupled to the network 110 to communicate an identification data of the mobile account to the mobile service provider module 114 to be verified and/or to provide access to the mobile account through the server 102A.

A gateway (e.g., the enterprise module 112 of FIGS. 1A-B) may bridge communications between the network 110 and the mobile network (e.g., the cellular network 116 and the telephone network 120) such that the gateway processes the identification data and/or communicates the identification data to the mobile service provider module 114 through the mobile network (e.g., the cellular network 116 and the telephone network 120). The virtual cell module 104 may communicate voice data between the network 110 and the mobile service provider module 114, such that the mobile service provider module 114 route the voice data to an intended recipient. The virtual cell module 104 may engage in a communication session (e.g., through the communication session module 210 of FIG. 2) to exchange the voice data with a user (e.g., the users 126A-N and the users 128A-N), such that the mobile service provider module 114 route the voice data between the virtual cell module 104 and the users 126A-N.

The virtual cell module 104 may generate an origination message data and/or communicate the origination message data between the network 110 and the mobile service provider module 114, such that the mobile service provider module 114 route the origination message data to an intended recipient.

The virtual cell module 104 may process an incoming message data (e.g., through incoming module 206 of FIG. 2) communicated by the mobile service provider module 114 through the network 110, such that the mobile service provider module 114 route the incoming message data to the virtual cell module 104 of the server 102A. The virtual cell module 104 may engage in a communication session (e.g., using the communication session module 210 of FIG. 2) to exchange the message data with another user (e.g., the users 126A-N and the users 128A-N), such that the mobile service provider module 114 route the message data between the virtual cell module 104 and another user.

The virtual cell module 104 may process meta-data communicated by the mobile service provider module 114 through the network 110, such that the mobile service provider module 114 route the meta-data to the virtual cell module 104 of the server 102A.

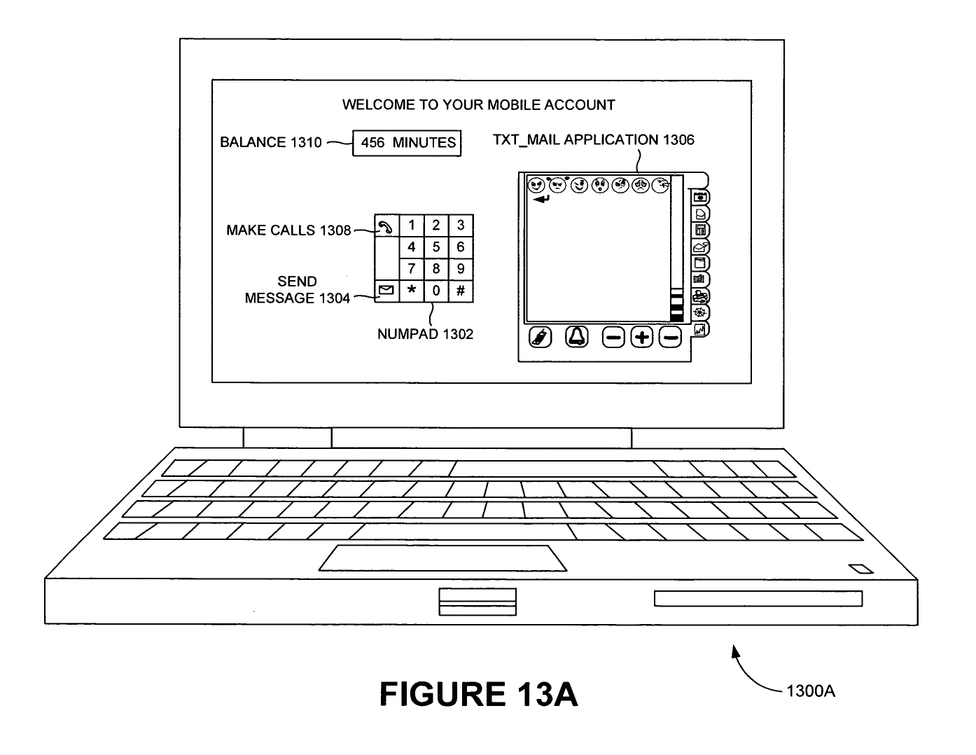

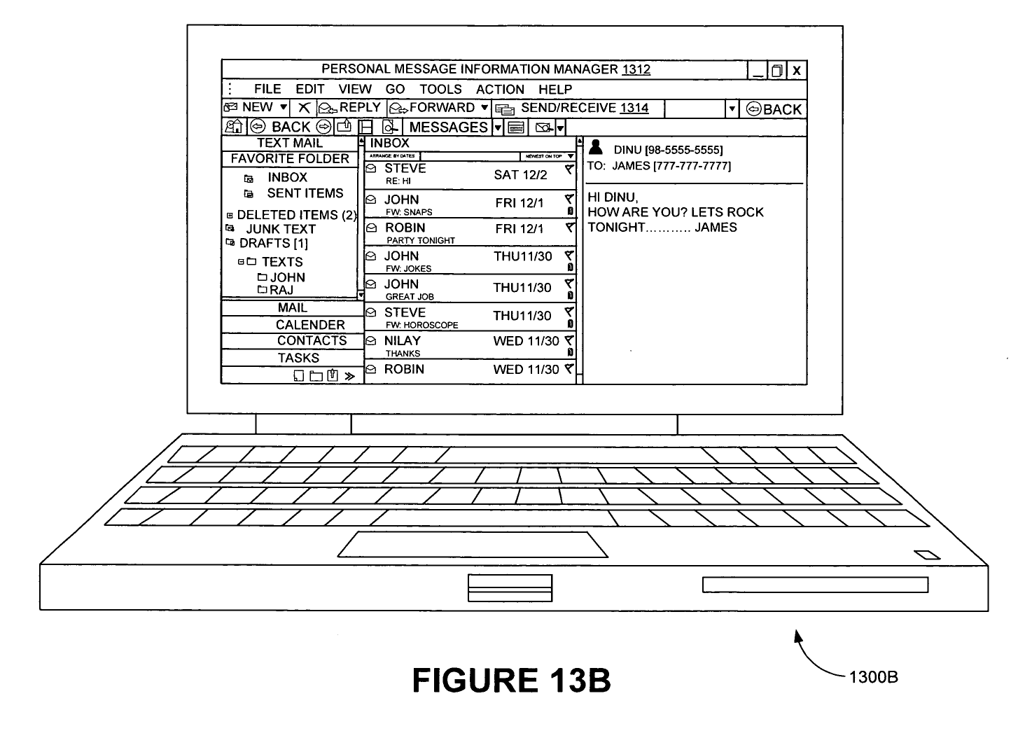

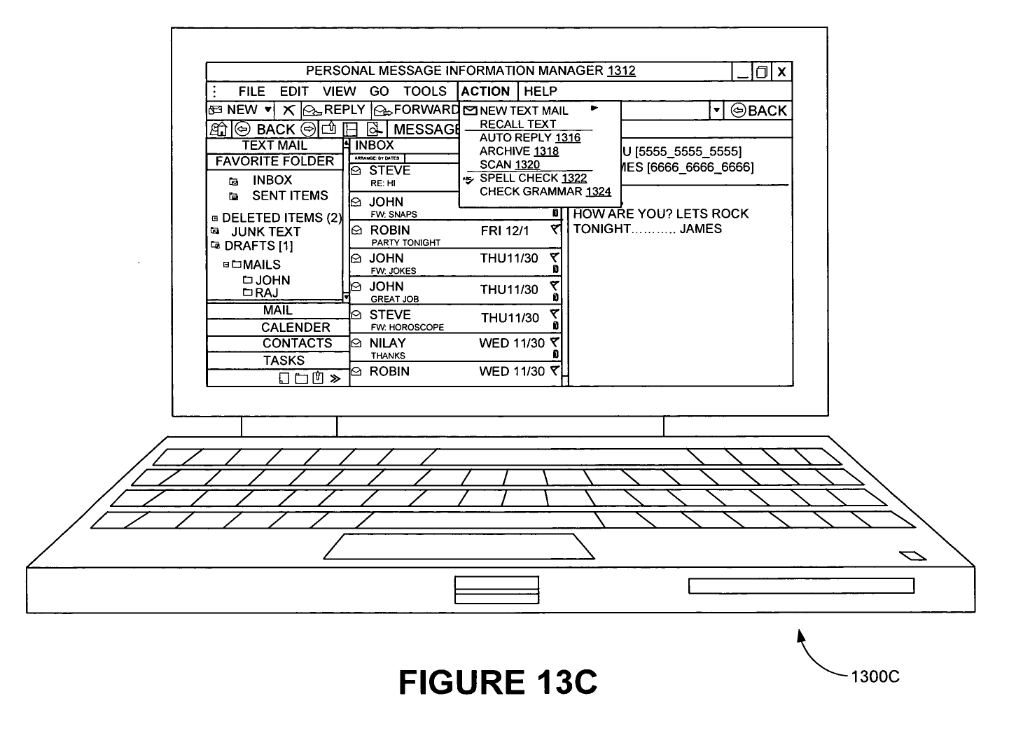

The integrity component (e.g., antivirus application, anti-spam application, anti-spyware application, anti-phishing application, etc.) of a personal message information manager (e.g., the personal message information manager 1312 of FIGS. 13B-C) may examine content of input and/or identify virus, trojan, phishing activity, denial of service, worm, adware, malware, spyware, and/or spam. In addition, the integrity component may quarantine and/or remove the virus, the trojan, the phishing activity, the denial of service, the worm, the adware, the malware, the spyware, and/or the spam from the content of the input.

FIG. 1B is a system view of the virtual cell module 104 of a personal computer 102B communicating with the cellular network 116 and the telephone network 120 through the network 110, according to one embodiment. Particularly, FIG. 1B illustrates the personal computer 102B, the virtual cell module 104, the associated application modules 106A-N, the network 110, the enterprise module 112, the mobile service provider module 114, the cellular network 116, the cell devices 118A-N, the telephone network 120, the telephones 122A-N, the content provider 124, the users 126A-N of the cell devices 118A-N, and the users 128A-N of the telephones 122A-N, according to one embodiment.

The personal computer 102B may be a desktop computer, a laptop computer, and/or a PDA which processes and/or executes data according to a list of instructions associated with the virtual cell module 104 to provide access to a set of services of the mobile account. The virtual cell module 104 may be an application embedded in the personal computer 102B which communicates data (e.g., identification data, voice data, message data, meta-data, etc.) associated with the mobile account of the users (e.g., the users 126A-N and the users 128A-N) to the mobile service provider module 114 through the network 110. The virtual cell module 104 may also provide access to the mobile account through the personal computer 102B.

The associated application modules 106A-N may be a web browser, anti-virus software, a word processor application, a dictionary, a media sharing application and/or a web property application embedded in the personal computer 102B that links and/or interoperates with the virtual cell module 104 to provide the set of services to the user of the mobile account. The network 110 may be a configuration of routers, access points, and/or gateways to securely communicate data (e.g., identification data, voice data, meta-data, etc.) packaged into packets using a suite of communication protocols and/or data models from the virtual cell module 104 of the personal computer 102B to the mobile service provider module 114. In addition, the network 110 may be coupled to the personal computer 102B to securely communicate data credited and/or debited to the mobile account through the personal computer 102B, such that the personal computer 102B and the mobile service provider module 114 communicate with each other using the mobile account.

The enterprise module 112 may be a gateway infrastructure (e.g., using a radio frequency) used to bridge communications between the network 110 coupled to the personal computer 102B and the mobile network (e.g., the cellular network 116 and the telephone network 120) of the mobile service provider module 114. The mobile service provider module 114 may be a structure (e.g., base station, base station controller, mobile switching office, etc.) of a mobile service provider which processes data communicated between a device of another user and the virtual cell module 104 embedded in the personal computer 102B and/or enables usage of services associated with the mobile account.

The cellular network 116 may be a network that enables accessing the set of services provided by the mobile service provider module 114 to the users 126A-N of the mobile account. The cell devices 118A-N may be a long-range, portable electronic device (e.g., PDA, cell phone, etc) used for accessing the set of services (e.g., sending/receiving messages, sending/receiving calls, etc.) associated with the mobile account of the user through the cellular network 116. The telephone network 120 may be a collection of telephones connected through a public wire line to the PSTN (Public Switched Telephone Network) which enables the communication of data (e.g., voice data, message data, meta-data, etc.) between the virtual cell module 104 of the personal computer 102B and the telephones 122A-N of the users 128A-N. The telephones 122A-N may be communication devices used to access the set of services provided by the virtual cell module 104 of the personal computer 102B through the telephone network 120.

The content provider 124 may provide contents (e.g., textual content, audio content, multimedia content, etc.) to the user(s) (e.g., the users 126A-N and the users 128A-N) of the mobile device (e.g., the cell devices 118A-N and the telephones 122A-N) through the mobile service provider module 114.

The users 126A-N may be entities (e.g., patron, business, organization, etc.) associated with the cell devices 118A-N that access the set of services associated with the virtual cell module 104 of the personal computer 102B. The users 128A-N may be entities (e.g., patron, business, organization, etc.) associated with the telephones 122A-N that access the set of services enabled by the virtual cell module 104 of the personal computer 102B through the mobile service provider module 114.

In the example embodiment as illustrated in FIG. 1B, the personal computer 102B having the virtual cell module 104 communicates with the mobile service provider module 114 through the network 110. The enterprise module 112 enables the communication between the network 110 coupled to the personal computer 102B and the mobile service provider module 114. The mobile service provider module 114 communicates directly with the content provider 124 to generate the contents associated with the mobile account.

The users 126A-N associated with the cell devices 118A-N communicates through the cellular network 116 to the mobile service provider module 114. The users 128A-N communicates with the mobile service provider module 114 through the telephone network 120 using the telephones 122A-N as illustrated in the example embodiment of FIG. 1B.

A gateway (e.g., the enterprise module 112) may bridge communications between the network 110 and the mobile network (e.g., the cellular network 116 and the telephone network 120) such that the gateway processes the identification data and/or communicates the identification data to the mobile service provider module 114 through the mobile network (e.g., the cellular network 116 and the telephone network 120).

The virtual cell module 104 may communicate voice data between the network 110 and the mobile service provider module 114, such that the mobile service provider module 114 route the voice data to an intended recipient. In addition, the virtual cell module 104 may engage in a communication session (e.g., through the communication session module 210 of FIG. 2) to exchange the voice data with a user (e.g., the users 126A-N and the users 128A-N), such that the mobile service provider module route the voice data between the virtual cell module 104 and the user.

The virtual cell module 104 may generate an origination message data and/or communicate the origination message data between the network 110 and the mobile service provider module 114, such that the mobile service provider module 114 route the origination message data to an intended recipient.

The virtual cell module 104 may engage in a communication session (e.g., through the communication session module 210 of FIG. 2) to exchange the message data with another user (e.g., the users 126A-N and the users 128A-N), such that the mobile service provider module 114 route the message data between the virtual cell module 104 and another user.

The mobile account of a user may be accessed using identification data associated with a mobile account through the personal computer 102B coupled to the network 110. A communication data may be processed between a device (e.g., the cell devices 118A-N, the telephones 122A-N) of another user and the personal computer 102B.

The integrity component (e.g., antivirus application, anti-spam application, anti-spyware application, anti-phishing application, etc.) of the personal message information manager 1312 may examine content of input and/or identify virus, trojan, phishing activity, denial of service, worm, adware, malware, spyware, and/or spam. In addition, the integrity component may quarantine and/or remove the virus, the trojan, the phishing activity, the denial of service, the worm, the adware, the malware, the spyware, and/or the spam from the content of the input.

Content communicated to the user (e.g., the users 126A-N and the users 128A-N of FIGS. 1A-B) of the mobile account and/or content generated by the user of the mobile account may be processed through an interface component of the personal message information manager 1312 of the virtual cell module 104 of a personal computer 102B. In addition, the content generated by the user of the mobile account may be analyzed for spelling error, formatting error, grammatical error, and/or semantic error.

The content communicated to the user (e.g., the users 126A-N and the users 128A-N of FIGS. 1A-B) of the mobile account may be examined in order to identify an unwanted, embedded program that poses a security risk. Moreover, the content generated by the user of the mobile account may be communicated between the network 110 and the mobile service provider such that the mobile service provider communicates the content to the intended recipient of the content generated by the user of the mobile account.

Virus, trojan, denial of service, adware, malware, and/or phishing program of the content communicated to the user of the mobile account may be identified. The virus, the trojan, the denial of service, the adware, the malware, and/or the phishing program may be sequestered from the content communicated to the user of the mobile account. The virus, the trojan, the denial of service, the adware, the malware, and/or the phishing program may be removed from the content communicated to the user of the mobile account.

The virtual cell module 104 may be embedded in the personal computer 102B. A message (e.g., text message, SMS message, video message, audio message, and/or multimedia message) may be processed by the personal message information manager 1312 of the personal computer 102B sent to the user of the mobile account. The personal message information manager 1312 of the virtual cell module 104 of the personal computer 102B may download from the mobile service provider the message (e.g., text message, SMS message, video message, audio message, multimedia message, etc.) of the mobile account. The set of services of the mobile account may be linked with an interface of an application of the personal computer 102B.

FIG. 2 is an exploded view of the virtual cell module 104 of FIGS. 1A-B, according to one embodiment. Particularly, FIG. 2 illustrates the associated application modules 106A-N, the client devices 108A-N, an input module 200, accessory devices 202A-N, a synchronization module 204, an incoming module 206, group of operation modules 208, a communication session module 210, a purchasing module 212, a message module 214, a data transfer module 216, a channel information module 218, a send module 220, a SIM card 222, an authentication module 224, and a delete module 226, according to one embodiment.

The input module 200 may process an input data from the client devices 108A-N coupled to the virtual cell module 104. The accessory devices 202A-N may be an apparatus (e.g., a headset, a Bluetooth-enabled device, an external hard drive, a flash memory unit, a printer, a scanner, a communication device, etc.) which processes and/or examines data in and/or out of the data processing system (e.g., the server 102A of FIG. 1A and the personal computer 102B of FIG. 1B). The synchronization module 204 may update information (e.g., contacts information, settings, preferences, messages uploaded to a message server of the mobile account, saved games, pictures, videos, audios, multimedia, web pages, etc.) associated with the user of the mobile device of the mobile account.

The incoming module 206 may process incoming data (e.g., text data, audio data, video data, etc.) communicated by the mobile service provider module 114 through the network 110. The group of operation modules 208 may contain any number of operation modules which perform a set of services associated with the mobile account of the user (e.g., the users 126A-N and the users 128A-N of FIGS. 1A-B).

The communication session module 210 may engage in the communication session to exchange voice data, text data, audio data, meta-data, etc. with another user associated the mobile account. The purchasing module 212 may provide premium content (e.g., applications, games, television shows, movies, songs, ring tones, etc.) and/or user-generated content (e.g., home movie, speech, etc.) to a data processing system (e.g., the server 102A of FIG. 1A and the personal computer 102B of FIG. 1B) by enabling the mobile account users to purchase (e.g., credit and/or debit the mobile account) a particular content.

The message module 214 may process a user input (e.g., text, audio, video, etc.) and/or generate a message to be communicated to another communication device (e.g., text message, SMS message, video message, audio message, voice mail, email, picture message, multimedia message, command-line message, etc.) through the network 110. The data transfer module 216 may perform a transfer of an entire file (e.g., multimedia file, executable file, text file, HTML file, XML file, etc.) to another device (e.g., the communication device, the personal computer 102B, the client devices 108A-N, etc.).

The channel information module 218 may provide information of channel (e.g., frequency) of communication assigned by a particular assessment method (e.g., CDMA, TDMA, FDMA, WDMA, Dynamic TDMA, W-CDMA, UMTS, WiMax, WiBro, etc.) of the mobile account, the mobile service provider module 114, the cellular network 116, the telephone network 120, and/or the mobile service provider. The send module 220 may communicate (e.g., process, generate, package into packets, encrypt, secure, spell-check, etc.) data (e.g., identification data, serial number data, device data, voice data, text data, multimedia data, etc.) of the virtual cell module 104 of the data processing system (e.g., the server 102A of FIG. 1A and the personal computer 102B of FIG. 1B) to the mobile service provider module 114 through the network 110.

The SIM card 222 (e.g., Subscriber Identity Module in GSM, Universal Subscriber Identity Module in Universal Mobile Telecommunications System (UMTS), etc.) may store and/or provide information of the mobile network and/or the mobile subscriber (e.g., the Location Area Identity) of the device associated with the mobile account. The authentication module 224 may provide identification and/or verification information of the mobile account (e.g., account number) and/or the mobile device associated with the account (e.g., MIN, ESN, separate authorization number provided by the mobile service provider of the mobile account) in order to authenticate the virtual cell module 104 and provide access of the mobile account through the virtual cell module 104. The delete module 226 may delete automatically the messages (e.g., text messages, audio messages, video messages, etc.) from a folder structure when the content associated with the messages is identified as unauthorized (e.g., SPAM message, received from blocked user, etc.).

In the example embodiment illustrated in FIG. 2, the input module 200 communicates with the client devices 108A-N, the associated application modules 106A-N, the accessory devices 202A-N, the synchronization module 204, and the group of operation modules 208. The group of operation modules 208 communicate with the incoming module 206, the communication session module 210, the purchasing module 212, the message module 214, the data transfer module 216, and the delete module 226.

The virtual cell module 104 may be embedded in the data processing system (e.g., the server 102A of FIG. 1A and the personal computer 102B of FIG. 1B). The purchasing module 212 of the virtual cell module 104 may request and/or download multimedia data from the content provider 124 coupled to the mobile service provider module 114 to display on the virtual cell module 104. The group of operation modules 208 may operate within the virtual cell module 104, such that each operation module performs a set of services associated with the mobile account.

The network 110 may be coupled to the data processing system (e.g., the server 102A of FIG. 1A and the personal computer 102B of FIG. 1B) to securely communicate data credited and/or debited to the mobile account through the data processing system, such that the data processing system and the mobile service provider module 114 communicate with each other using the mobile account. A number of applications (e.g., the associated application modules 106A-N of FIGS. 1A-B and 2) of the data processing system may link and/or interoperate with the group of operation modules 208 of the virtual cell module 104.

A data of an application (e.g., the associated application modules 106A-N of FIGS. 1A-B) may be communicated through the network 110 to the mobile service provider module 114 to relay to a receiver. The data by the application relayed from the mobile service provider module 114 to the virtual cell module 104 may be processed through the network 110 from a transferor.

The purchasing module 212 may communicate an order of a media content and/or a mobile service associated with the mobile account to the mobile service provider, such that the media content and/or the mobile service to be provided to the virtual cell module 104 of the user of the mobile account and/or to be debited from the mobile account. The purchasing module 212 of the personal message information manager 1312 may communicate an order of media contents and/or mobile services to the mobile service provider to be provided to a mobile device of the user of the mobile account. The auto-reply module of the personal message information manager 1312 may generate and/or communicate a preset message to a sender of the message(s).

The send module 220 may communicate input between the network 110 and the mobile service provider, such that the mobile service provider route the content to an intended recipient. The delete module 226 of the personal message information manager 1312 may remove the message(s). The synchronization module 204 of the personal message information manager 1312 may update and/or harmonize information of the user associated with the mobile device (e.g., the cell devices 118A-N and the telephones 122A-N of FIGS. 1A-B) of the mobile account with the personal message information manager 1312.

A message may be classified according to set of preferences of the user of the mobile account. An appropriate folder structure of the personal message information manager 1312 may be determined according to the set of preferences of the user.

The message may be deleted (e.g., using the delete module 226 of FIG. 2) automatically from a folder structure of messages from blocked users of the personal message information manager 1312. The message may be deleted (e.g., through the delete module 226 of FIG. 2) automatically from a folder structure of SPAM of the personal message information manager 1312. A predefined reply message may be generated (e.g., through auto-reply module) and/or communicated to a sender of the message.

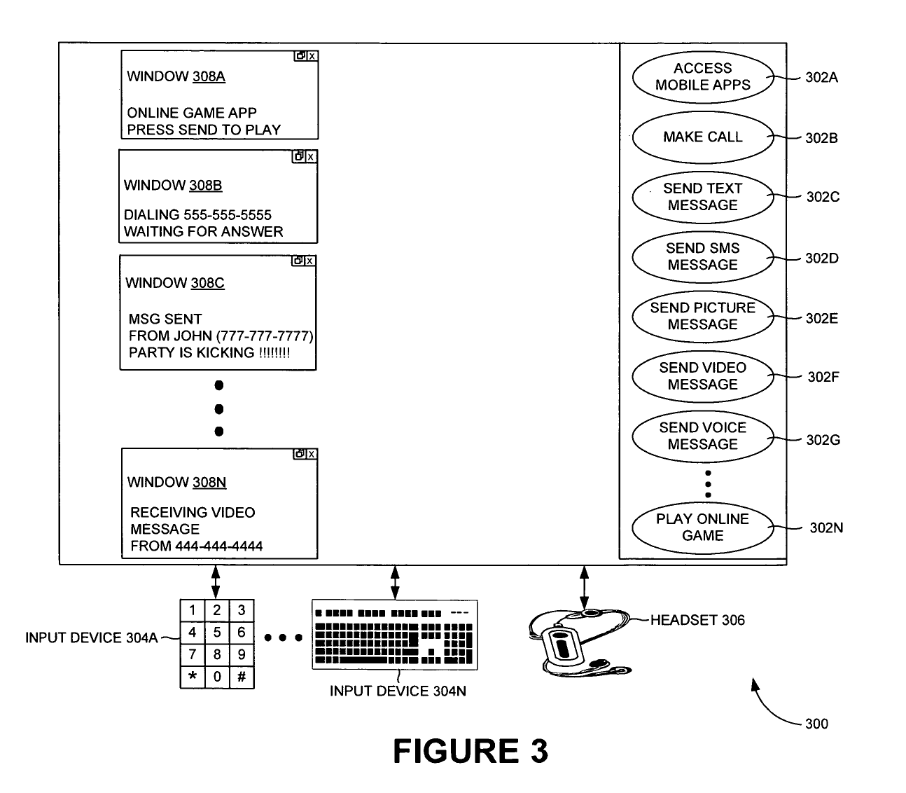

FIG. 3 is a graphical interface view of the virtual cell module 104 of FIGS. 1A-B, according to one embodiment. Particularly, FIG. 3 illustrates a virtual cell module 104, options 302A-N, input devices 304A-N, a headset 306 and windows 308A-N, according to one embodiment.

The options 302A-N may enable accessing of the set of services associated with the mobile account of the user. For example, the option 302A may enable the user of a mobile device (e.g., cell device, telephone, etc.) to access mobile applications provided by the mobile service provider. The option 302B may enable the user of the mobile account to make call to another user. The option 302C may enable the user of the mobile device to communicate textual content to other users of the mobile device. The option 302D may facilitate the user to send SMS (short message service) messages through interface of the virtual cell module 104 to another user of the mobile device. The option 302E may enable the user of the mobile account to send picture message through the send picture message option 302E.

The option 302F may allow the user to send video message to other users of the mobile account. The option 302G may enable the user to send voice message to other users. The option 302N may enable the user to play online games with another user. The input devices 304A-N may be a computer mouse, a computer keyboard, a headset, a number pad, a scanner, a trackball, a joystick, a light pen and/or a free space controller used for inputting data (e.g., multimedia data, textual data, voice data, a phone number, etc.) to be communicated to the virtual cell module 104. The input device 304A may be a telephone numpad which enables the user to input a phone number associated with another user. The input device 304N may be a keyboard which enables the user to input textual data.

The headset 306 may be coupled to the data processing system (e.g., the server 102A of FIG. 1A and the personal computer 102B of FIG. 1B) to input voice data to the virtual cell module 104 of the data processing system. The windows 308A-N may be the number of session windows of the graphical user interface of the virtual cell module 104 which exchanges data with the user, the number of input consoles and/or the group of operation modules 208.

In the example embodiment illustrated in FIG. 3, the graphical interface view 300 of the virtual cell module 104 displays the options 302A-N. The graphical interface view 300 displays the windows 308A-N. The window 308A displays an action of requesting to play a game. The window 308B displays a status of the calls made. The window 308C displays details related to text message status. The window 308N displays status of a video message from a particular user.

A graphical user interface (e.g., the graphical interface view 300 of FIG. 3) of the virtual cell module 104 may have a number of session windows (e.g., windows 308A-N), such that each session window to exchange data with the user (e.g., the users 126A-N and the users 128A-N of FIGS. 1A-B), a number of input consoles (e.g., the input devices 304A-N of FIG. 3), and the group of operation modules 208 linked to the graphical interface 300. The headset apparatus 306 may be coupled to the data processing system (e.g., the server 102A of FIG. 1A and the personal computer 102B of FIG. 1B) to input voice data to the graphical interface view 300 of the virtual cell module 104.

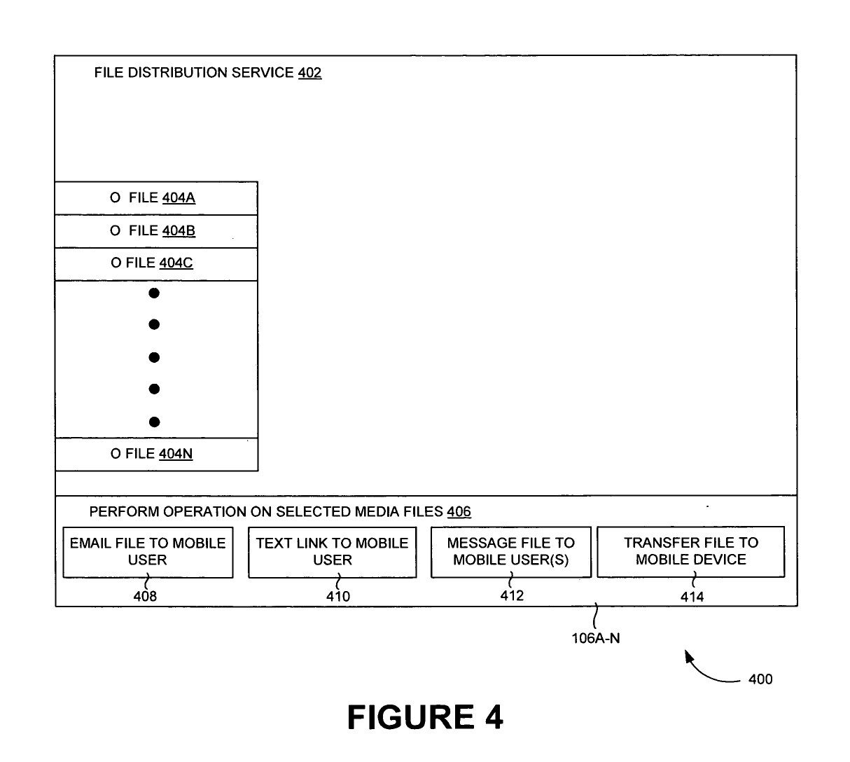

FIG. 4 is an interface view of the associated application modules 106A-N of FIGS. 1A-B, according to one embodiment. Particularly, FIG. 4 illustrates a file distribution service 402, files 404A-N, a perform operation on selected media files link 406, an email file to mobile user link 408, a text link to mobile user link 410, a message file to mobile user(s) link 412 and a transfer file to my mobile device link 414, according to one embodiment. The file distribution service 402 may organize data (e.g., video, text, voice, etc.) into the any number of folder structures based on classification of the data.

The files 404A-N may be data files in any of various formats (e.g., *.mp3, *.avi, *.doc, etc.) The perform operation on selected media files link 406 may enable the user of the mobile account to perform various mobile related data transfer actions. The email file to mobile user link 408 may enable the user to email a file (e.g., video, text, voice, etc.) to any other mobile user. The text link to mobile user link 410 may enable the user to send a text link to other mobile user through the mobile network. The message file to mobile user(s) link 412 may facilitate the user to send message files (e.g., video, text, voice, media, etc.) to other mobile users. The transfer file to my mobile device link 414 may enable the user of the mobile device to transfer files (e.g., video, text, voice, etc.) to any mobile device.

In the example embodiment illustrated in FIG. 4, the interface view 400 displays the files 404A-N which contains the files that are organized based on the pre-set classification. The interface view 400 of the associated application modules 106A-N may enable the user (e.g., the users 126A-N and the users 128A-N of FIGS. 1A-B) to perform various operations like sending emails to the mobile devices through the email file to mobile user link 408, sending text links to any mobile user through the text link to mobile user link 410, sending a message with the file through the message file to mobile user(s) link 412 and transferring file to his/her own mobile device through the transfer file to my mobile device link 414.

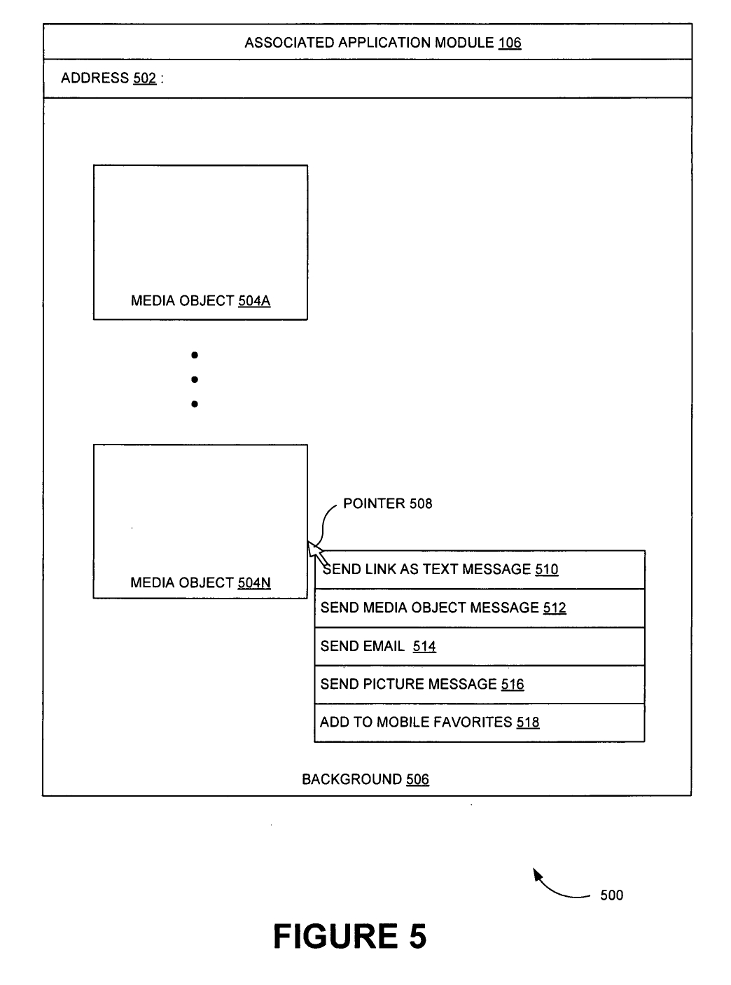

FIG. 5 is an interface view of the associated application modules 106A-N of FIGS. 1A-B, according to one embodiment. Particularly, FIG. 5 illustrates an address 502, a media objects 504A-N, a background 506, a pointer 508, a send link as text message link 510, a send media object message link 512, a send email link 514, a send picture message link 516 and an add to mobile favorites link 518, according to one embodiment.

The address 502 link may be a hyperlink to a website containing HTML documents and/or media objects. The media objects 504A-N may be a video, an audio, and/or a multimedia object. The background 506 may be a HTML document background. The pointer 508 may enable the user to perform various action(s) through an input device (e.g., an optical mouse, roller mouse, etc). The send link as text message link 510 may provide the user to send a link in text format to another user of a mobile device.

The send media object message link 512 may enable the user to send media object messages to other mobile users through the mobile service provider module 114. The send email link 514 may enable the user of the data processing system (e.g., the server 102A of FIG. 1A and the personal computer 102B of FIG. 1B) associated with the virtual cell module 104 to send emails to another mobile user. The send picture message link 516 may enable the user of the mobile account to send the picture messages to other mobile users associated with the mobile device. The add to mobile favorites link 518 may enable the user to add the selected messages (e.g., video, text, voice, etc.) to a specific file destination (e.g., favorite folder).

In the example embodiment illustrated in FIG. 5, the interface view 500 displays various media objects 504A-N on the screen. The interface view 500 displays various links to enable the user to send link as text message, send media object message, send email, send picture message and add to mobile favorites.

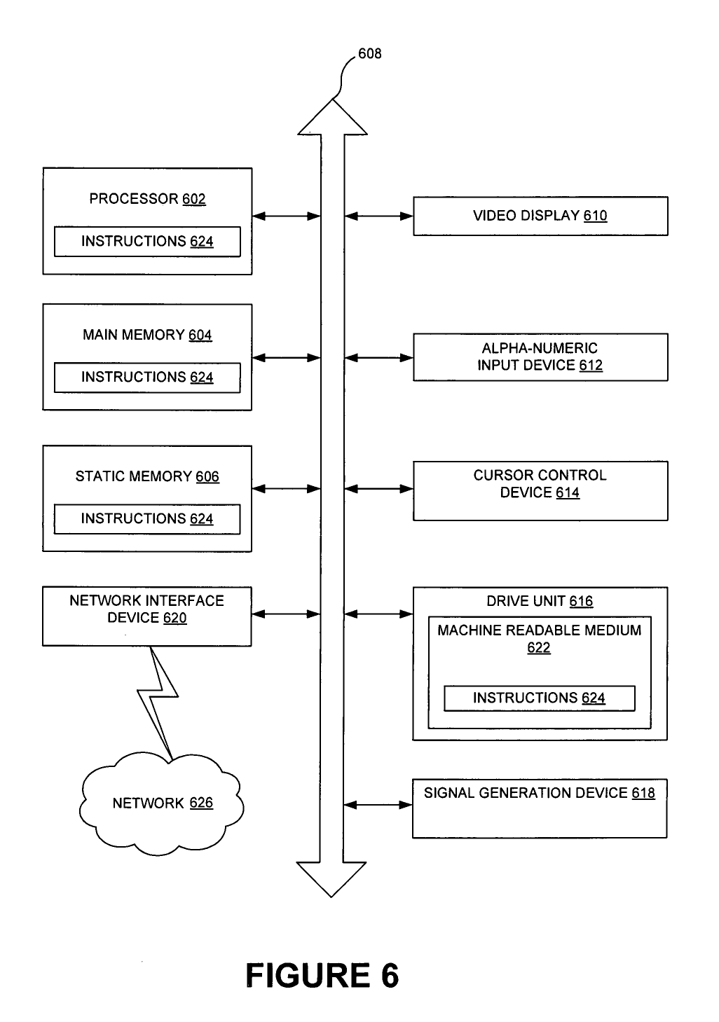

FIG. 6 is a diagrammatic system view 600 of a data processing system in which any of the embodiments disclosed herein may be performed, according to one embodiment. Particularly, the diagrammatic system view 600 of FIG. 6 illustrates a processor 602, a main memory 604, a static memory 606, a bus 608, a video display 610, an alpha-numeric input device 612, a cursor control device 614, a drive unit 616, a signal generation device 618, a network interface device 620, a machine readable medium 622, instructions 624, and a network 626, according to one embodiment.

The diagrammatic system view 600 may indicate the data processing system in which one or more operations disclosed herein are performed. The processor 602 may be microprocessor, a state machine, an application specific integrated circuit, a field programmable gate array, etc. (e.g., Intel® Pentium® processor). The main memory 604 may be a dynamic random access memory and/or a primary memory of a computer system.

The static memory 606 may be a hard drive, a flash drive, and/or other memory information associated with the data processing system. The bus 608 may be an interconnection between various circuits and/or structures of the data processing system. The video display 610 may provide graphical representation of information on the data processing system. The alpha-numeric input device 612 may be a keypad, keyboard and/or any other input device of text (e.g., a special device to aid the physically handicapped).

The cursor control device 614 may be a pointing device such as a mouse. The drive unit 616 may be a hard drive, a storage system, and/or other long term storage subsystem. The signal generation device 618 may be a bios and/or a functional operating system of the data processing system. The network interface device 620 may be a device that performs interface functions, such as code conversion, protocol conversion, and/or buffering, required for communication to and from a network.

The machine readable medium 622 may provide instructions on which any of the methods disclosed herein may be performed. The instructions 624 may provide source code and/or data code to the processor 602 to enable any one/or more operations disclosed herein.

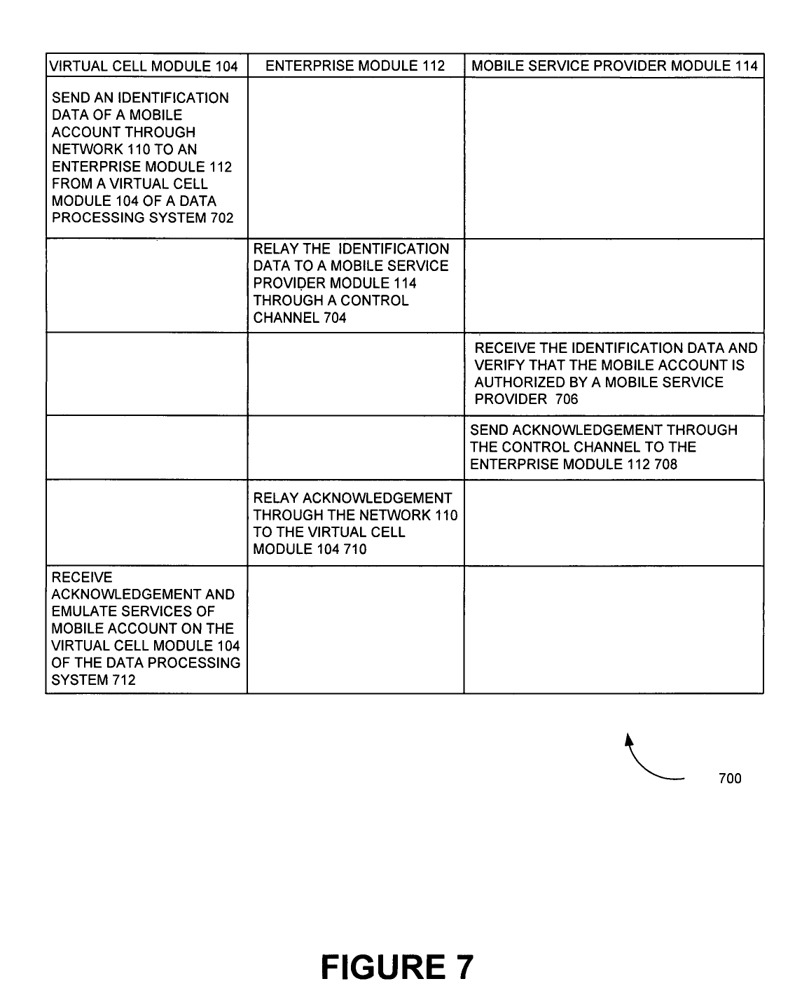

FIG. 7 is an interaction diagram of the virtual cell module 104, the enterprise module 112, and the mobile service provider module 114 of FIGS. 1A-B, according to one embodiment. In operation 702, the virtual cell module 104 sends an identification data of the mobile account through the network 110 to the enterprise module 112. In operation 704, the enterprise module 112 relays the identification data to the mobile service provider module 114 through a control channel (e.g., the channel information module 218 of FIG. 2). In operation 706, the mobile service provider module 114 receives the identification data and verifies that the mobile account is authorized by a mobile service provider.

In operation 708, the mobile service provider module 114 sends an acknowledgement through the control channel to the enterprise module 112. In operation 710, the enterprise module 112 relays the acknowledgement through the network 110 to the virtual cell module 104. In operation 712, the virtual cell module 104 receives the acknowledgement and emulates services of mobile account on the virtual cell module 104 of the data processing system (e.g., the server 102A of FIG. 1A and the personal computer 102B of FIG. 1B).

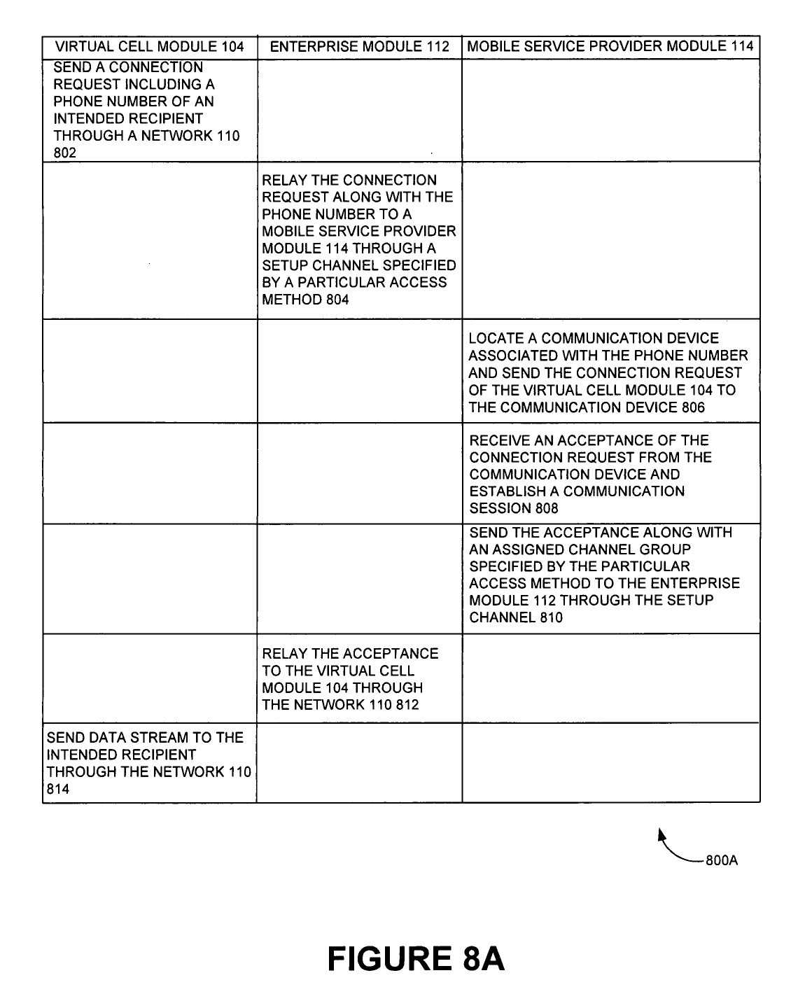

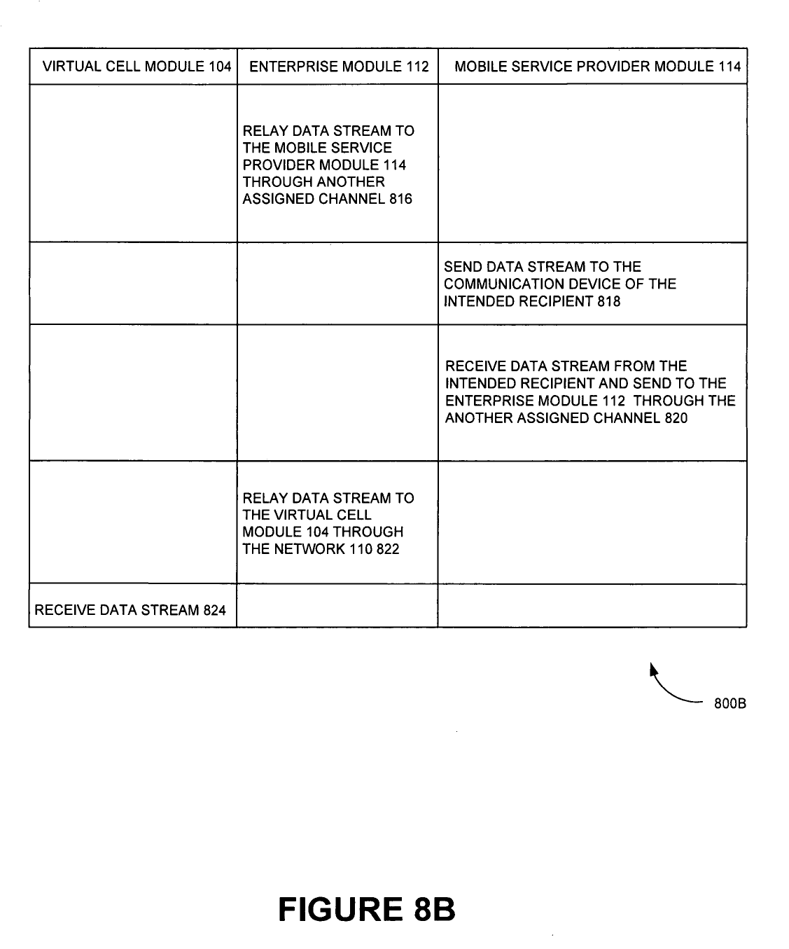

FIG. 8A is an interaction diagram of the virtual cell module 104, the enterprise module 112, and the mobile service provider module 114 of FIGS. 1A-B, according to one embodiment. In operation 802, the virtual cell module 104 sends a connection request including a phone number of an intended recipient through the network 110.

In operation 804, the enterprise module 112 relays the connection request along with the phone number to the mobile service provider module 114 through a setup channel specified by a particular access method. In operation 806, the mobile service provider module 114 locates a communication device (e.g., the cell devices 118A-N and the telephones 122A-N of FIGS. 1A-B) associated with the phone number and sends the connection request of the virtual cell module 104 to the communication device.

In operation 808, the mobile service provider module 114 receives an acceptance of the connection request from the communication device and establishes a communication session (using the communication session module 210 of FIG. 2). In operation 810, the mobile service provider module 114 sends the acceptance along with an assigned channel group specified by the particular access method to the enterprise module 112 through the setup channel. In operation 812, the enterprise module 112 relays the acceptance to the virtual cell module 104 through the network 110. In operation 814, the virtual cell module 104 sends data stream to the intended recipient through the network 110.

FIG. 8B is a continuation of the interaction diagram of the virtual cell module 104, the enterprise module 112, and the mobile service provider module 114 of FIGS. 1A-B, according to one embodiment. In operation 816, the enterprise module 112 relays data stream to the mobile service provider module 114 through another assigned channel. In operation 818, the mobile service provider module 114 sends data stream to the communication device (e.g., the cell devices 118A-N and the telephones 122A-N of FIGS. 1A-B) of the intended recipient (e.g., the users 126A-N and the users 128A-N of FIGS. 1A-B).

In operation 820, the mobile service provider module 114 receives data stream from the intended recipient and sends to the enterprise module 112 through the another assigned channel (e.g., the channel information module 218 of FIG. 2). In operation 822, the enterprise module 112 relays data stream to the virtual cell module 104 through the network 110. In operation 824, the virtual cell module 104 receives data stream.

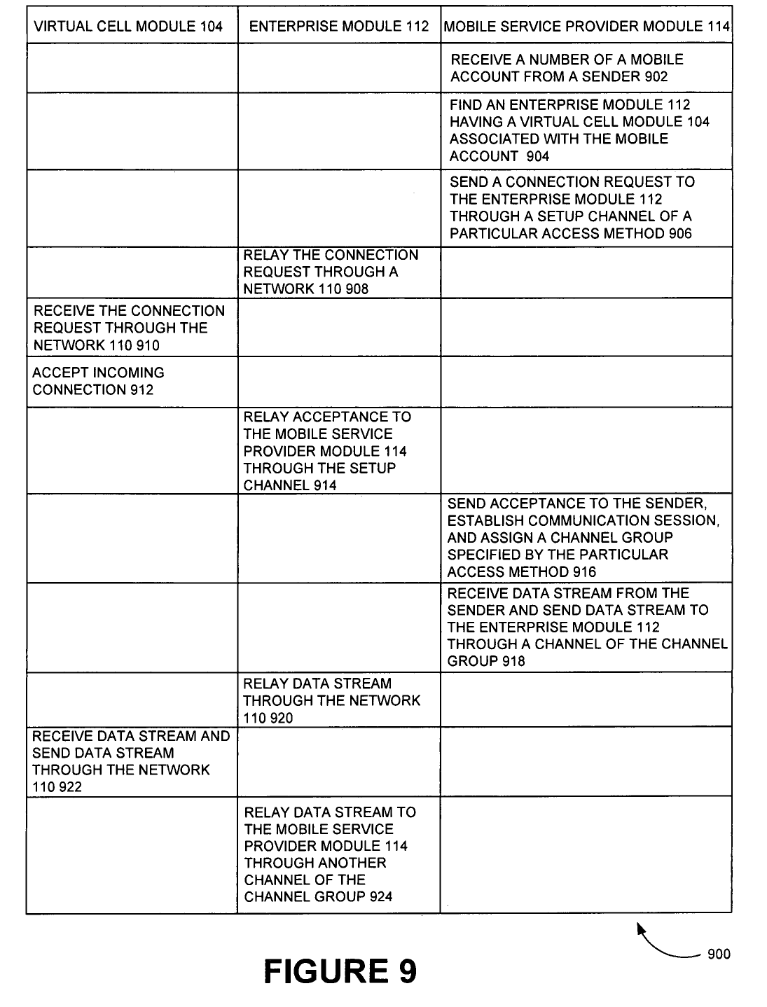

FIG. 9 is an interaction diagram of the virtual cell module 104, the enterprise module 112, and the mobile service provider module 114 of FIGS. 1A-B, according to one embodiment. In operation 902, the mobile service provider module 114 receives a number of a mobile account from a sender. In operation 904, the mobile service provider module 114 finds an enterprise module 112 having the virtual cell module 104 associated with the mobile account. In operation 906, the mobile service provider module 114 sends a connection request to the enterprise module 112 through a setup channel (e.g., the channel information module 218 of FIG. 2) of a particular access method.

In operation 908, the enterprise module 112 relays the connection request through the network 110. In operation 910, the virtual cell module 104 receives the connection request through the network 110. In operation 912, the virtual cell module 104 accepts incoming connection. In operation 914, the enterprise module 112 relays acceptance to the mobile service provider module 114 through the setup channel. In operation 916, the mobile service provider module 114 sends acceptance to the sender, establishes communication session (e.g., through the communication session module 210 of FIG. 2), and assigns a channel group specified by the particular access method.

In operation 918, the mobile service provider module 114 receives data stream from the sender and sends data stream to the enterprise module 112 through a channel (e.g., the channel information module 218). In operation 920, the enterprise module 112 relays data stream through the network 110. In operation 922, the virtual cell module 104 receives data stream and sends data stream through the network 110. In operation 924, the enterprise module 112 relays data stream to the mobile service provider module 114 through another channel of the channel group.

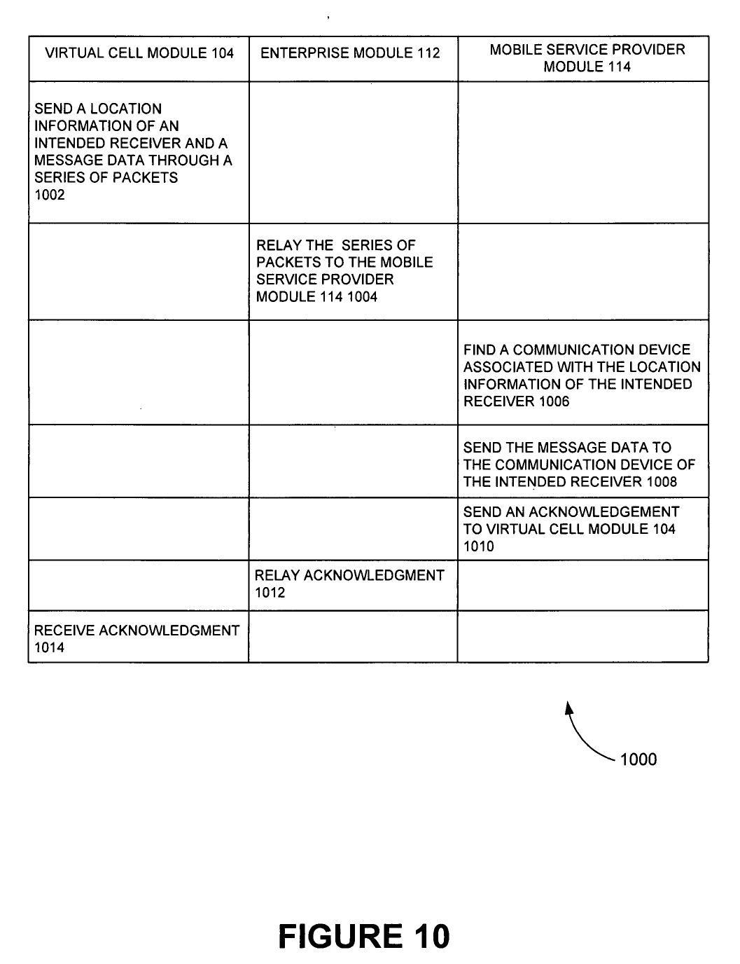

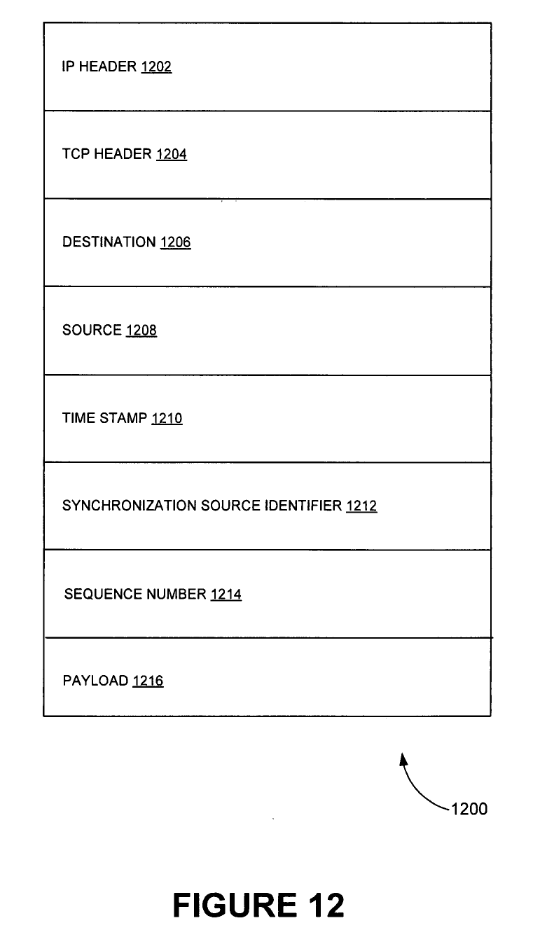

FIG. 10 is an interaction diagram of the virtual cell module 104, the enterprise module 112, and the mobile service provider module 114 of FIGS. 1A-B, according to one embodiment. In operation 1002, the virtual cell module 104 sends a location information of an intended receiver and a message data through a series of packets (e.g., the packet view as illustrated in FIG. 12). In operation 1004, the enterprise module 112 relays the series of packets to the mobile service provider module 114.

In operation 1006, the mobile service provider module 114 finds a communication device (e.g., the cell devices 118A-N and the telephones 122A-N of FIGS. 1A-B) associated with the location information of the intended receiver (e.g., the users 126A-N and the users 128A-N of FIGS. 1A-B). In operation 1008, the mobile service provider module 114 sends the message data to the communication device of the intended receiver. In operation 1010, the mobile service provider module 114 sends an acknowledgement to virtual cell module 104. In operation 1012, the enterprise module 112 relays acknowledgement. In operation 1014, the virtual cell module 104 receives acknowledgement.

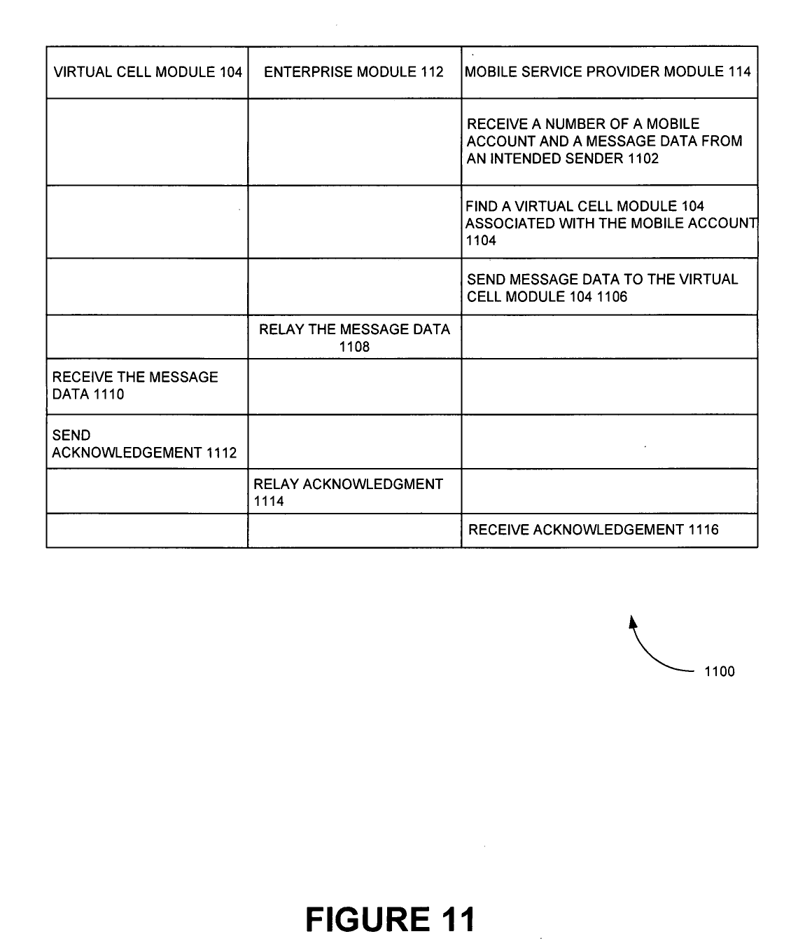

FIG. 11 is an interaction diagram of the virtual cell module 104, the enterprise module 112, and the mobile service provider module 114 of FIGS. 1A-B, according to one embodiment. In operation 1102, the mobile service provider module 114 receives a number of a mobile account and a message data from an intended sender. In operation 1104, the mobile service provider module 114 finds the virtual cell module 104 associated with the mobile account.

In operation 1106, the mobile service provider module 114 sends message data (e.g., using the send module 220 of FIG. 2) to the virtual cell module 104. In operation 1108, the enterprise module 112 relays the message data. In operation 1110, the virtual cell module 104 receives the message data (e.g., through the incoming module 206 of FIG. 2). In operation 1112, the virtual cell module 104 sends acknowledgement. In operation 1114, the enterprise module 112 relays acknowledgement. In operation 1116, the mobile service provider module 114 receives acknowledgement.

FIG. 12 is a packet view of a packet sent from the virtual cell module 104 through the network 110, according to one embodiment. Particularly, FIG. 12 illustrates a packet 1200, an IP header 1202, a TCP header 1204, a destination 1206, a source 1208, a timestamp 1210, a synchronization source identifier 1212, a sequence number 1214, and a payload 1216, according to one embodiment.

The packet 1200 may be a structured object (e.g., multiple fields of data comprising a transmission unit) of a transmission protocol (e.g., RCP, TCP/IP, UDP). The IP header 1202 may be a segment of data that contains information (e.g., source IP address and port, destination IP address and port, transmission flags, maximum transmission unit size, payload size, etc.) relevant to the Internet Protocol (IP) between the virtual cell module 104 of the data processing system (e.g., the server 102A of FIG. 1A and the personal computer 102B of FIG. 1B) and the enterprise module 112 or the mobile service provider module 114.

The TCP header 1204 may be a segment of data that contains information (e.g., source IP address and port, destination IP address and port, transmission flags, maximum transmission unit size, payload size, etc.) relevant to the Transmission Control Protocol (TCP) between the virtual cell module 104 of the data processing system and the enterprise module 112 or the mobile service provider module 114. The destination 1206 may contain information (e.g., the recipient's mobile number, email address, etc.) relating to the destination of the data in the payload.

The source 1208 may contain information relating to the source of the data of the payload (e.g., the senders phone number). The timestamp 1210 may be part of the order-routing process in which the time of day is stamped on an order. The synchronization source identifier 1212 may be a segment of data that identifies the source of the transmission (e.g., by assigning a random n-bit integer to the particular source).

The sequence number field 1214 may be a segment of data indicating a position of the packet 1200 in a sequence of packets including the multimedia segment being transferred to the enterprise module, the mobile service provider module, and/or the virtual cell module 104. The payload 1216 may be a segment of data that represents a portion of the data to be sent to the destination.

In an alternate embodiment, the TCP header 1204 may be a UDP header (i.e., universal datagram protocol). In another alternate embodiment, the TCP header 1204 may be a segment of data that contains information relevant to the Transmission Control Protocol (TCP) between the virtual cell module 104 and the mobile service provider module 114.

FIG. 13A is an interface view of the mobile account and a TXT_MAIL application 1306, according to one embodiment. Particularly, FIG. 13A illustrates a num-pad 1302, a send message link 1304, a TXT_MAIL application 1306, a make calls option 1308 and a balance option 1310, according to one embodiment. The num-pad 1302 may provide the user to connect to another user of the mobile device by dialing desired numbers. The send message link 1304 may enable the user to send messages to a desired mobile/telephone number.

The TXT_MAIL application 1306 may enable the user of the mobile account to write, read, display, modify, receive and/or send messages to be communicated to another user of the mobile device. The make calls option 1308 may enable the user to communicate the voice data to another user through the graphical interface of the virtual cell module 104 through dialing a number in the num-pad 1302. The balance option 1310 may display balance time left to access the service provided by the mobile service provider module (e.g., the mobile service provider module 114 of FIGS. 1A-B).

In the example embodiment illustrated in FIG. 13A, the interface view 1300A displays the TXT_MAIL application 1306. In addition, the interface view 1300A enables the user (e.g., the users 126A-N and the users 128A-N of FIGS. 1A-B) to view details associated with the user of the mobile account. The interface view 1300A enables the user to make calls to mobile device and/or send messages using the num-pad 1302.

FIG. 13B is an interface view of the mobile account the personal message information manager 1312, according to one embodiment. Particularly, FIG. 13B illustrates a personal message information manager 1312 and a send/receive link 1314, according to one embodiment. The personal message information manager 1312 may enable the user of the mobile account to download content from the mobile service provider. The send/receive link 1314 may display status of the messages been sent or received (e.g., time, errors, etc.). In addition, the send/receive link 1314 may enable the user to send and/or receive the messages from the mobile service provider.

In the example embodiment illustrated in FIG. 13B, the interface view 1300B displays the graphical interface of the personal message information manager 1312. The interface view 1300B displays the folder structures associated with user of the mobile account. The interface view 1300B facilitates the user to download messages of the mobile account. The user may also view the details related to the status of the messages sent or received by the send/receive link 1314. In addition, the interface view 1300B facilitates the user to organize, manage, access and/or display information associated with the mobile account.

FIG. 13C is an interface view of the mobile account and the personal message information manager 1312, according to one embodiment. Particularly, FIG. 13C illustrates an auto reply option 1316, an archive option 1318, a scan option 1320, a spell check option 1322 and a check grammar option 1324, according to one embodiment. The personal message information manager 1312 may classify and organize the messages in the folder structure. Also, the personal message information manager 1312 may contain an interface component which processes the content and/or identifies the potential error(s). The auto reply option 1316 may generate and/or communicate a preset message to a sender of message.

The archive option 1318 may move text messages older than a certain date to another data file for retrieval at a later time. The scan option 1320 may identify and/or sequester virus, trojan, denial of service, adware, malware, and/or phishing program from content communicated to the user of the mobile account. The spell check option 1322 may check for any misspell in the message inputted by the user. The check grammar option 1324 may identify any grammatical mistakes in the message inputted by user.

In the example embodiment illustrated in FIG. 13C, the interface view 1300C displays various options such as auto reply, spell check, check grammar, etc. The interface view 1300C may enable the user to process the input (e.g., textual input, video input, etc.) and suggest modification in the message on identification of the potential error. The user (e.g., the users 126A-N and the users 128A-N of FIGS. 1A-B) may correct spellings and/or grammar of the message typed. The interface view 1300C may enable the user to scan the messages for any virus attack through the scan option 1320. In addition the interface view 1300C may facilitate the user to organize, manage, access and/or display information associated with the mobile account.

The personal message information manager 1312 of the virtual cell module 104 of the data processing system (e.g., the server 102A of FIG. 1A) may download from the mobile service provider a message (e.g., text message, SMS message, video message, audio message, multimedia message, etc.) of the mobile account.

A number of folder structures of the personal message information manager 1312 may organize the message based on a classification of the message and/or may archive the message in order to later refer to the message of the mobile account. A set of preferences may enable classification and/or organization of the message into any of the number of folder structures. The auto-reply module of the personal message information manager 1312 may generate and/or communicate a preset message to a sender of any one of the message.

The interface component of the personal message information manager 1312 may process an input (e.g., textual input, audio input, video input, multimedia input, etc.) of the user (e.g., the users 126A-N and the users 128A-N of FIGS. 1A-B) of the mobile account. The interface component may analyze a content of the input of the user (e.g., the users 126A-N and the users 128A-N of FIGS. 1A-B) of the mobile account and/or identify a potential error of the input.

The interface component may suggest a modification (e.g., the modification may be spelling change, grammatical change, semantic change, formatting change, etc.) of the content of the input based on the potential error identified by an analysis of the content of the input. The integrity component of the personal message information manager may examine the content of the input and identify virus, trojan, phishing activity, denial of service, worm, adware, malware, spyware, and/or spam. In addition, the integrity component may quarantine and/or remove the virus, the trojan, the phishing activity, the denial of service, the worm, the adware, the malware, the spyware, and/or the spam from the content of the input.

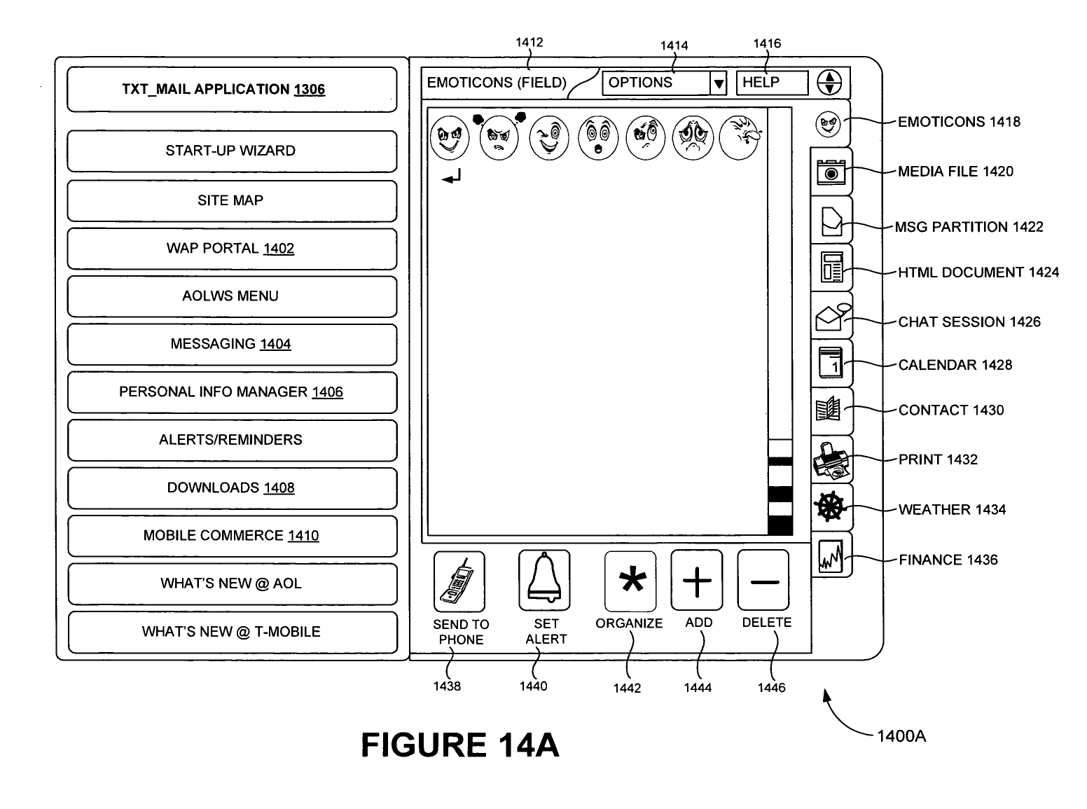

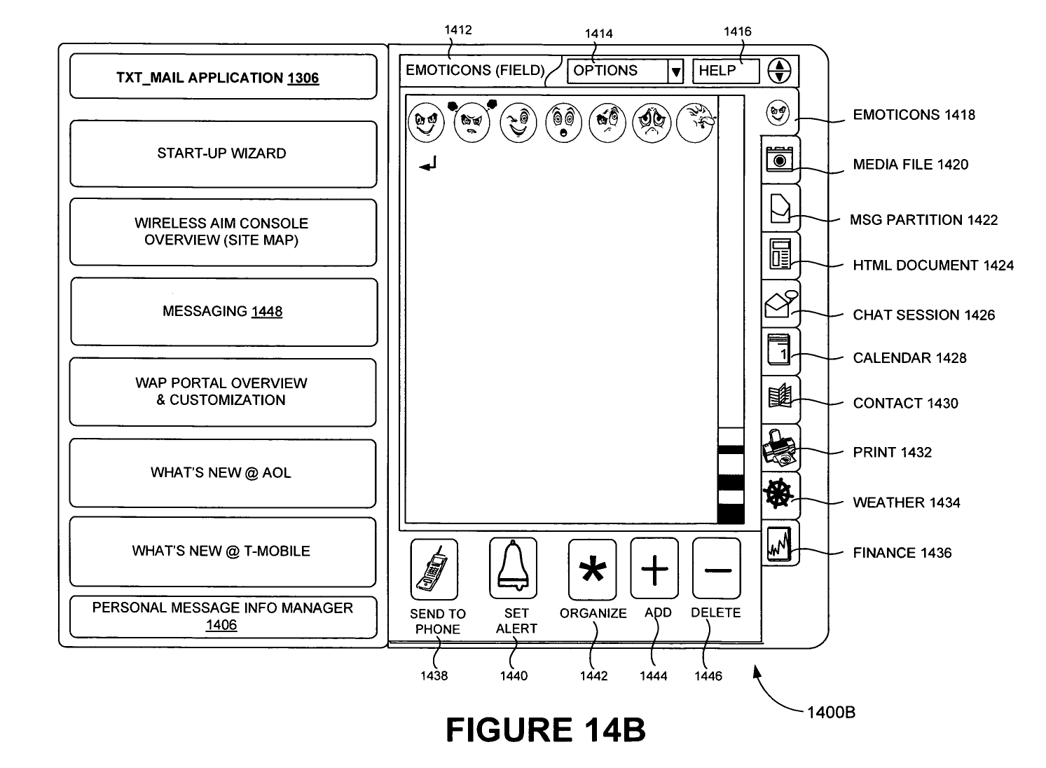

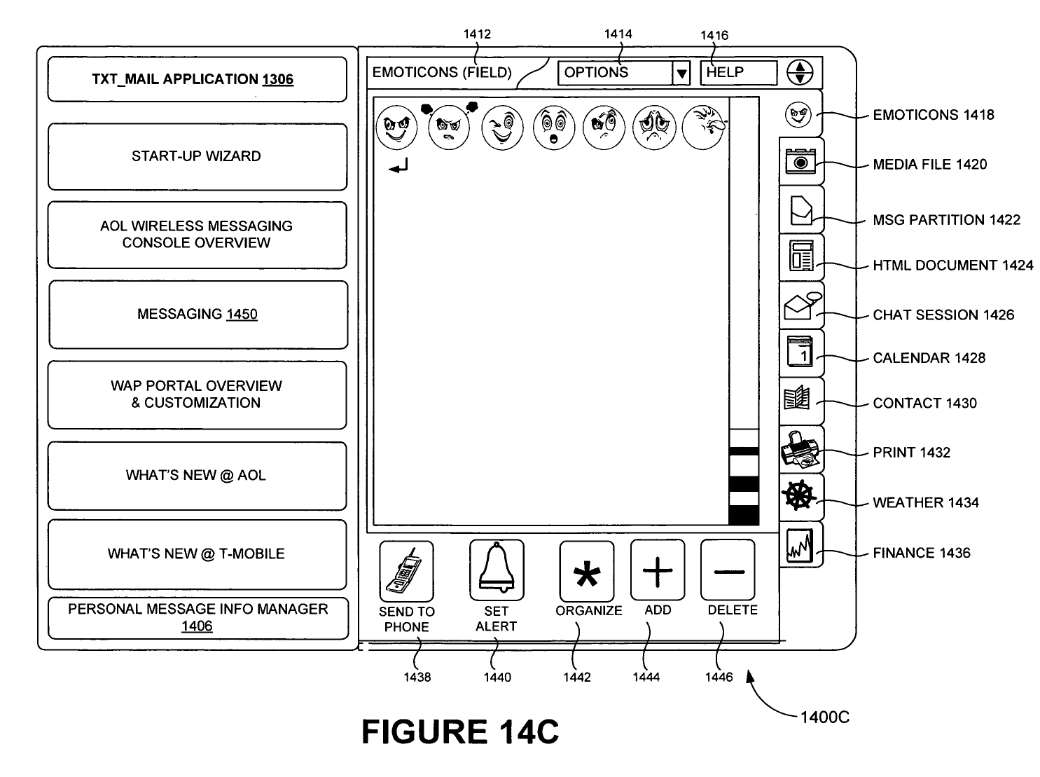

FIG. 14A is an interface view of the TXT_MAIL application 1306, according to one embodiment. Particularly, FIG. 14A illustrates the TXT_MAIL application 1306, a WAP portal option 1402, a messaging option 1404, a personal message info manager option 1406, downloads option 1408, a mobile commerce option 1410, a emoticons (field) option 1412, options 1414, a help option 1416, an emoticons option 1418, a media file option 1420, a message partition option 1422, a html document option 1424, a chat session option 1426, a calendar option 1428, a contact option 1430, a print option 1432, a weather option 1434, a finance option 1436, a send to phone option 1438, a set alert option 1440, an organize option 1442, an add option 1444 and a delete option 1446, according to one embodiment.

The WAP (Wireless Application Protocol) portal option 1402 may be a protocol for wireless communication which enables access of the internet using the mobile account and/or the mobile device. The messaging option 1404 may provide information related to instant messaging (e.g., AIM). The messaging option 1404 may enable the user of the mobile account to view, send and/or receive message. The personal message info manager option 1406 may be associated with processing of a content communicated to a user of a mobile account and/or a content generated by the user of the mobile account.

The download option 1408 may provide the user to download contents (e.g., media files, picture messages) from the mobile service provider. The mobile commerce option 1410 may enable the user to trade, buy, sell and/or exchange contents provided by the mobile service provider. The emoticons (field) option 1412 may display the emoticons on the display screen of the mobile account user. The options 1414 may analyze and/or examine the content associated with the user of the mobile account.

The help option 1416 may enable the user of the mobile account user to avail any help for queries related to accessing of the mobile account. The emoticons option 1418 may enable the mobile account user to use emoticons in the messages. The media file option 1420 may display the media files provided by the mobile service provider. The message partition option 1422 may facilitate partitioning of the messages to the mobile account user. The HTML document option 1424 may facilitate the user of the mobile account to view documents, messages, and/or emails in HTML format. The chat session option 1426 may enable the mobile account user to have a chat session with other mobile account users. The calendar option 1428 may display almanac and/or yearly details.

The contact option 1430 may display the contacts (e.g., names, address, phone number etc) saved by the user. The print option 1432 may enable the mobile account user to obtain printout of any desired documents. The weather option 1434 may offer information associated with the weather forecast to the mobile account user. The finance option 1436 may offer information associated with finances to the mobile account user. The send to phone option 1438 may allow the user to send contents to other mobile account user. The set alert option 1440 may provide the mobile account user with alerts on receiving contents and/or error.

The organize option 1442 may enable the user to organize the contents of the mobile account user. The add option 1444 may enable the mobile account user to add contents to the mobile account. The delete option 1446 may enable the mobile account user to delete contents associated with the mobile account.

In the example embodiment the interface view illustrated in FIG. 14A, the TXT_MAIL application 1306 enables the user to download contents (e.g., media files, picture messages, etc.) provided by the mobile service provider module 114.

FIG. 14B is an interface view of the TXT_MAIL application 1306, according to one embodiment. Particularly, FIG. 14B illustrates, the TXT_MAIL application 1306, the personal message info manager option 1406, the emoticons (field) 1412, the options 1414, the help option 1416, the emoticons option 1418, the media file option 1420, the message partition option 1422, the HTML document option 1424, the chat session option 1426, the calendar option 1428, the contact option 1430, the print option 1432, the weather option 1434, the finance option 1436, the send to phone option 1438, the set alert option 1440, the organize option 1442, the add option 1444, the delete option 1446 and a messaging option 1448, according to one embodiment. The messaging option 1448 may provide information related to instant messaging (e.g., AIM) and/or may facilitate the user(s) to send, classify, and organize messages.

In the example embodiment the interface view illustrated in FIG. 14B, the TXT_MAIL application 1306 may enable the user to view other user available for chatting through the site map.

FIG. 14C is an interface view of the TXT_MAIL application 1306, according to one embodiment. Particularly, FIG. 14C illustrates the TXT_MAIL application 1306, the personal message info manager option 1406, the emoticons (field) 1412, the options 1414, the help option 1416, the emoticons option 1418, the media file option 1420, the message partition option 1422, the HTML document option 1424, the chat session option 1426, the calendar option 1428, the contact option 1430, the print option 1432, the weather option 1434, the finance option 1436, the send to phone option 1438, the set alert option 1440, the organize option 1442, the add option 1444, the delete option 1446 and a messaging option 1450, according to one embodiment.

The TXT_MAIL application 1306 may provide the user of the mobile account to add, write, read, display, modify, receive and/or send messages. The messaging 1450 may enable the user communicate the message (e.g., AIM) with another user. In the example embodiment the interface view illustrated in FIG. 14C, the TXT_MAIL application 1306 displays messaging options which enable the user to add, write, display, modify, receive and/or send messages.

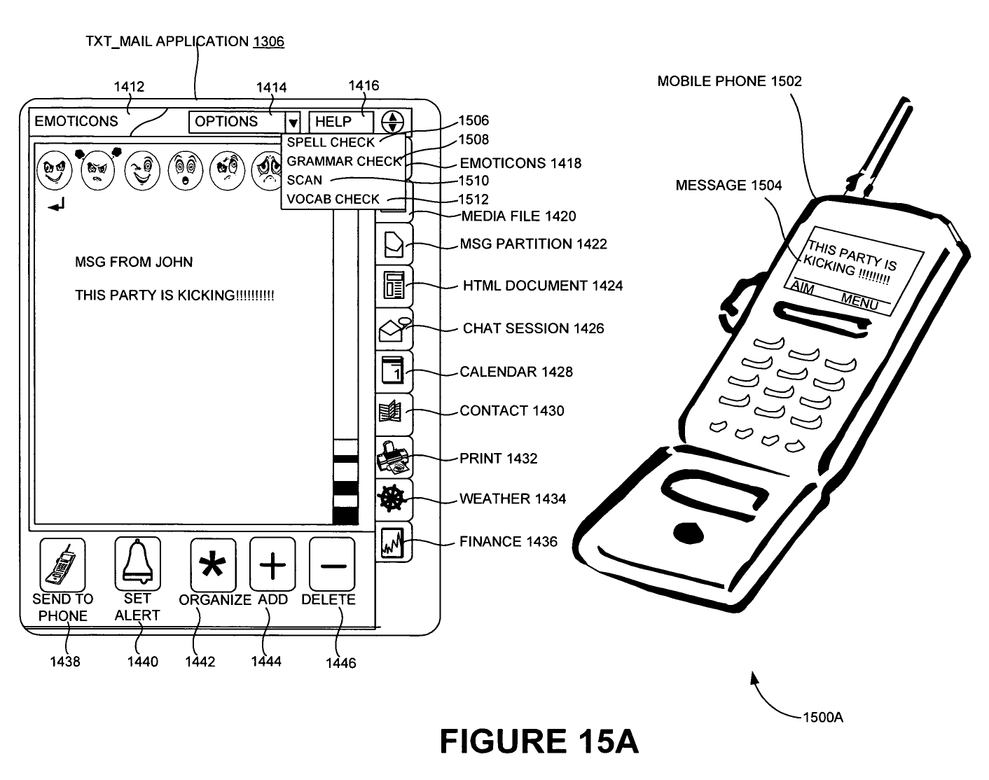

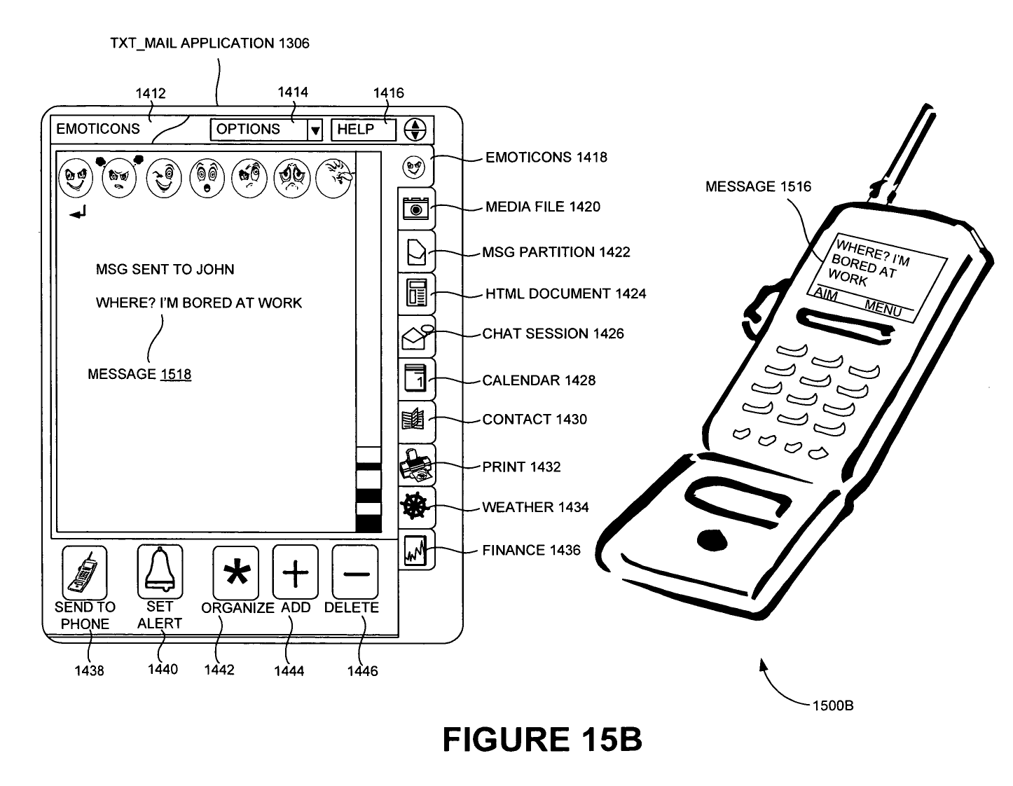

FIG. 15A is a messaging view of the TXT_MAIL application 1306 and a mobile phone 1502, according to one embodiment. Particularly, FIG. 15A illustrates the TXT_MAIL application 1306, a mobile phone 1502, a message 1504, a spell check option 1506, a grammar check option 1508, a scan option 1510 and a vocab check option 1512, according to one embodiment.

The mobile phone 1502 may be the device associated with the mobile account user used to access the set of services. The message 1504 may be content received from the mobile account user. The spell check option 1506 may check for any misspell in the message inputted by the user. The grammar check option 1508 may identify any grammatical errors in the message to be communicated to another user of the mobile account. The scan option 1510 may scan to identify virus, trojan, denial of service, adware, malware, and/or phishing program from the content communicated to the user of the mobile account. The vocab check option 1512 may check and/or modify any errors in the vocabulary text associated with the message.

In the example embodiment illustrated in FIG. 15A, the messaging view 1500A may enable the user to scan, spell check, check grammatical errors, etc. through options 1414. The messaging view 1500A displays message received from the mobile user in the TXT_MAIL application 1306.

The interface component of the personal message information manager 1312 may process an input (e.g., textual input, audio input, video input, and/or multimedia input) of the user (e.g., the users 126A-N of FIG. 1A) of the mobile account. The interface component may analyze a content of the input of the user (e.g., the users 126A-N and the users 128A-N of FIGS. 1A-B) of the mobile account and/or may identify a potential error of the input.

The interface component may suggest a modification (e.g., the modification may be spelling change, grammatical change, semantic change, formatting change, etc.) of the content of the input based on the potential error identified by an analysis of the content of the input. The integrity component of the personal message information manager may examine the content of the input and identify virus, trojan, phishing activity, denial of service, worm, adware, malware, spyware, and/or spam. In addition, the integrity component may quarantine and/or may remove the virus, the trojan, the phishing activity, the denial of service, the worm, the adware, the malware, the spyware, and/or the spam from the content of the input.

FIG. 15B is a messaging view of the TXT_MAIL application 1306 and the mobile phone 1502, according to one embodiment. Particularly, FIG. 15B illustrates the TXT_MAIL application 1306, a message 1516, a message 1518, according to one embodiment. The message 1516 may be a text message received on a mobile device of another mobile account user. The message 1518 may be the text message displayed in the TXT_MAIL application 1306 sent by the user associated with the virtual cell module 104 of the data processing system (e.g., the server 102A of FIG. 1A and the personal computer 102B of FIG. 1B)

In the example embodiment illustrated in FIG. 15B, the messaging view 1500B displays the text message sent by the user of the mobile account in the TXT_MAIL application 1306. In addition, the messaging view 1500B displays the text message received on the mobile device from the user of the mobile account.

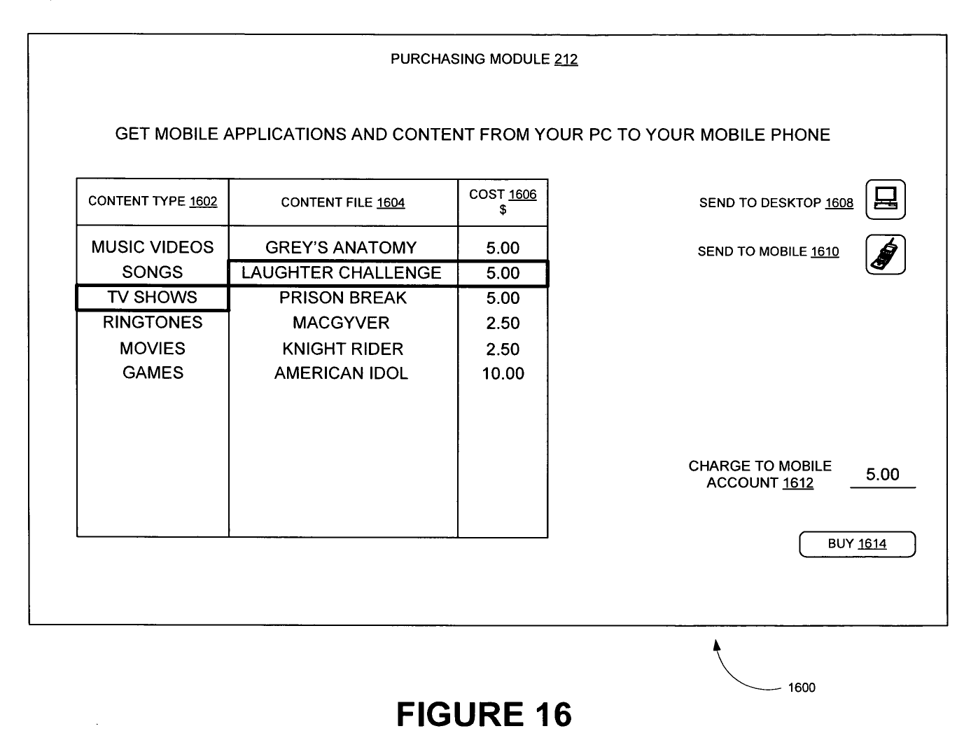

FIG. 16 is an interface view of the purchasing module 212 of FIG. 2, according to one embodiment. Particularly, FIG. 16 illustrates a content type field 1602, a content file field 1604, a cost field 1606, a send to desktop link 1608, a send to mobile link 1610, a charge to mobile account 1612 and a buy link 1614, according to one embodiment.

The content type field 1602 may be different types (e.g., music videos, songs, TV shows, ring tones, movies, games, etc.) of the content provided by the mobile service provider. The user may choose any type of the content that he/she likes. The content file field 1604 may consist of different multimedia content (e.g., Grey's Anatomy, Laughter Challenge, Prison Break, MacGyver, Knight Rider, American Idol, etc.) available for download. The cost field 1606 may display price associated with different media content which are available for downloading.

The send to desktop link 1608 may enable the user to send the particular content file field 1604 associated with the particular content type field 1602 to the desktop of the data processing system (e.g., the personal computer 102B of FIG. 1B) of the user. The send to mobile link 1610 may enable the user to selected content file (e.g., Grey's Anatomy, Laughter Challenge, Prison Break, MacGyver, Knight Rider, American Idol, etc.) of a particular content type (e.g., music videos, songs, TV shows, ring tones, movies, games, etc.) having a predefined cost to the user's mobile phone.

The charge to mobile account 1612 may offer the information associated with the cost of the content and/or the mobile applications purchased by the user through graphical interface of the purchasing module 212. The buy link 1614 may enable the user to communicate order of the mobile applications and/or content of a particular type.

In the example embodiment illustrated in FIG. 16, the interface view 1600 of the purchasing module 212 enables the user (e.g., mobile account subscriber) to purchase online mobile applications and/or the media content. The interface view 1600 displays the content type field 1602 which contains music videos, songs, TV shows, ringtones, movies, games, etc. The interface view 1600 also displays the content files associated with the content type field 1602 in the content file field 1604. The interface view 1600 displays price associated with the particular content file. The interface view 1600 enables the user to buy and/or transfer mobile application and/or content to the mobile device.

For example, the purchasing module 212 of the virtual cell module 104 may request and/or may download multimedia data from the content provider 124 coupled to the mobile service provider module 114 to display on the virtual cell module 104. The purchasing module 212 may communicate an order of a media content and/or a mobile service associated with the mobile account to the mobile service provider, such that the media content and/or the mobile service to be provided to the virtual cell module 104 of the user (e.g., the users 126A-N and the users 128A-N of FIGS. 1A-B) of the mobile account and/or to be debited from the mobile account. The purchasing module 212 of the personal message information manager 1312 may communicate an order of media content and/or mobile services to the mobile service provider to be provided to a mobile device of the user of the mobile account.

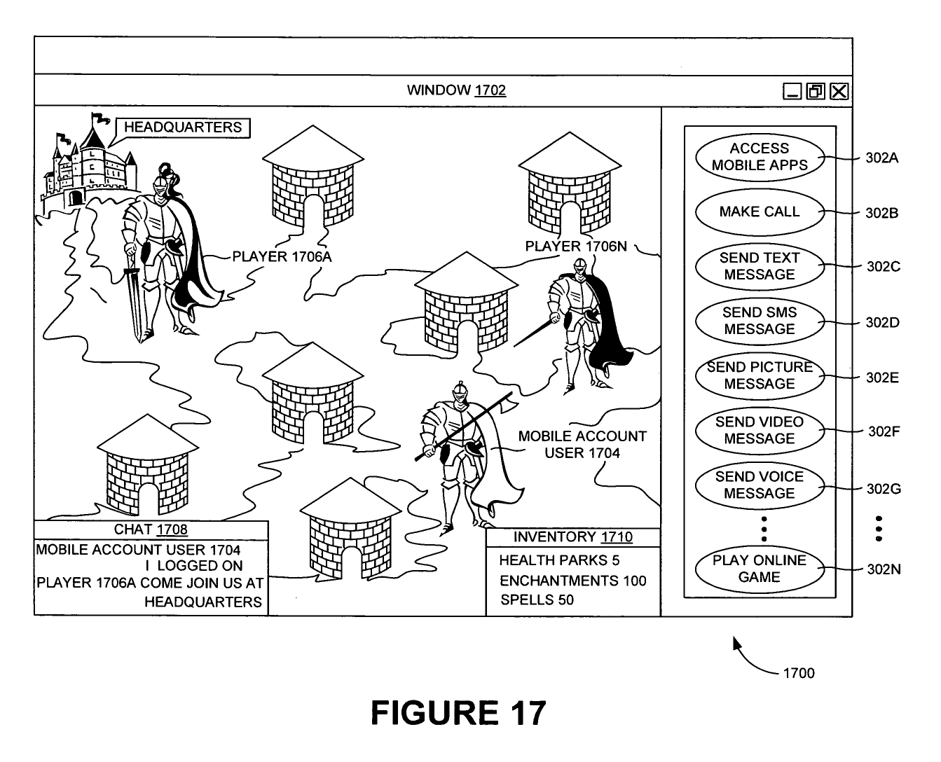

FIG. 17 is an interface view of an interactive game of the mobile account, according to one embodiment. Particularly, FIG. 17 illustrates the options 302A-N, a window 1702, a mobile account user 1704, players 1706A-N, a chat 1708 and an inventory 1710, according to one embodiment.

The options 302A-N may perform any of the services associated with the mobile account. The window 1702 may enable the mobile account user to play interactive games with another user. The mobile account user 1704 may be an active participant in the game provided by the mobile service provider. The players 1706A-N may be other mobile account users participating in the game associated with the user of the mobile account. The chat 1708 may display the comments and/or conversations between the mobile account user and the players 1706A-N participating in the game. The inventory 1710 may be a list of items belonging to the mobile account user.

In the example embodiment illustrated in FIG. 17, the window 1702 displays the graphical interface associated with the interactive game. The interface view 1700 may facilitate the user to chat with other mobile account user participating in the interactive game. The interface view 1700 displays inventory information associated with the mobile account user 1704 during the interactive game session through inventory 1710. An interactive application of the mobile account may be engaged, such that the mobile service provider module 114 communicates and/or processes data of the interactive application through the network 110.

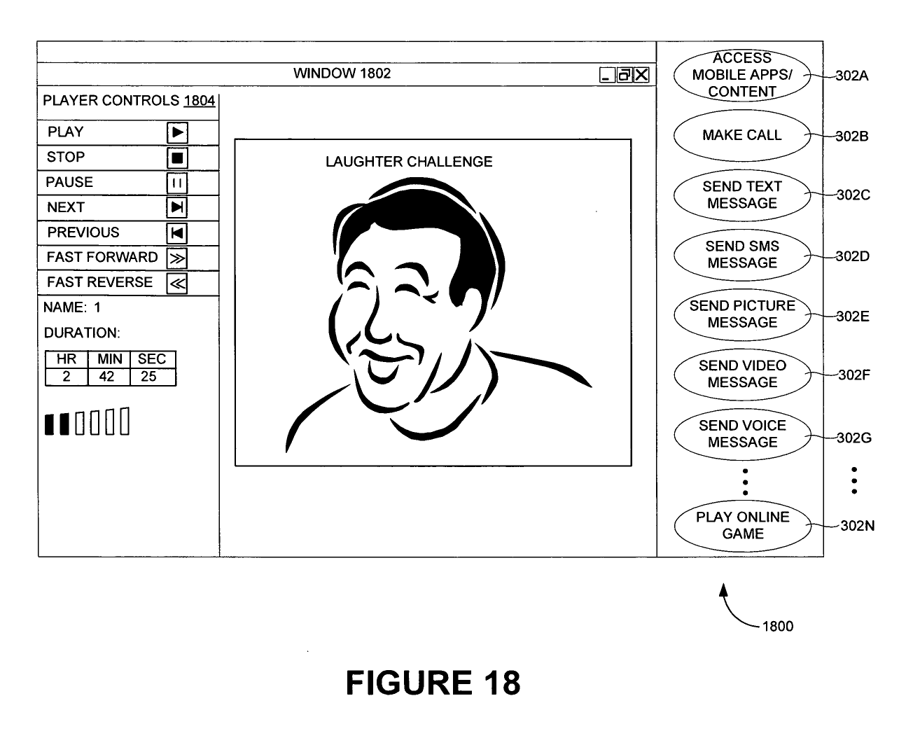

FIG. 18 is an interface view of a content of the mobile account, according to one embodiment. Particularly, FIG. 18 illustrates the options 302A-N, a window 1802 and player controls 1804, according to one embodiment.

The options 302A-N may enable the user to access any of the services associated with the mobile account. The window 1802 may display multi media contents which are generated by the mobile account user. The player controls 1804 facilitate the user to adjust controls (e.g., play, stop, forward, reverse, pause, etc.) associated with the content of the mobile service provider module 114.

In the example embodiment illustrated in FIG. 18, the interface view 1800 displays various controls to enable the user to access the multimedia content generated by the user of the mobile account. The interface view 1800 may enable the user to view the multimedia content through a graphical interface of the virtual cell module 104.

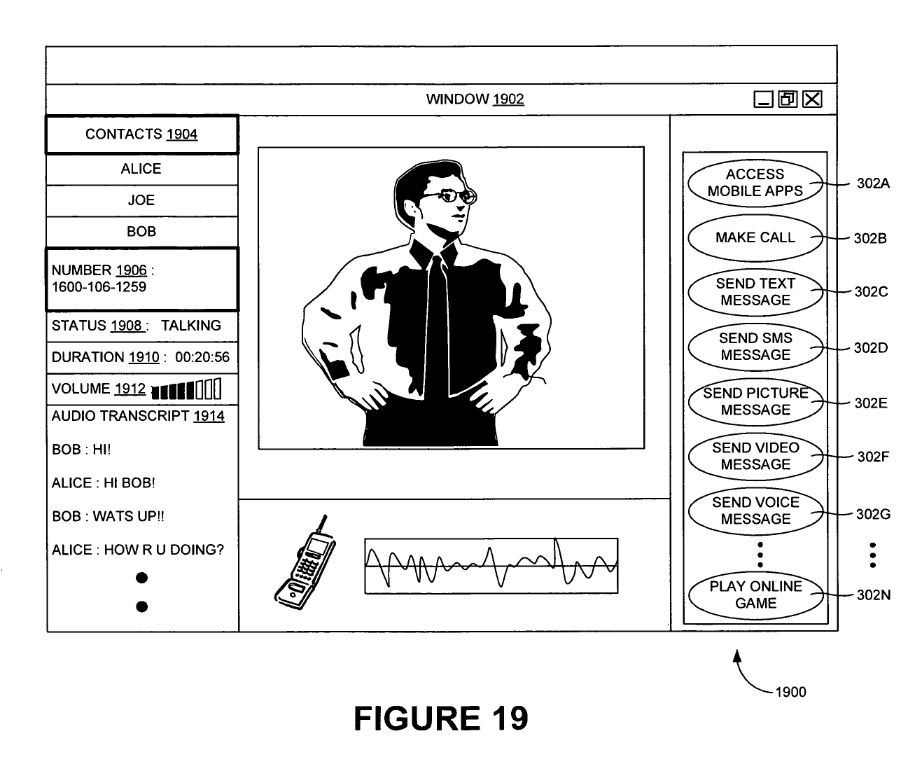

FIG. 19 is an interface view of the communication session module 210 of FIG. 2, according to one embodiment. Particularly, FIG. 19 illustrates the options 302A-N, a window 1902, contacts 1904, a number 1906, a status 1908, duration 1910, a volume 1912, and an audio transcript 1914, according to one embodiment.

The window 1902 may be a session window associated with the graphical user interface of the virtual cell module 104. The window 1902 may be associated with a communication session between the user of the data processing system (e.g., the server 102A of FIG. 1A and the personal computer 102B of FIG. 1B) and the user associated with a mobile device (e.g., the cell devices 118A-N and the telephones 122A-N of FIGS. 1A-B). The contacts 1904 may be contact information of the entities associated with the user of the mobile account. The number 1906 may be a contact number associated with the mobile account through which the communication session is engaged.

The status 1908 may be a status of the communication session between the user of the mobile account and another user. The duration 1910 may be a record of time for which the communication session is engaged. The volume 1912 shows voice level set by the user during the communication session. The audio transcript 1914 may be a record which displays conversation that took place between the user and another user.

In the example embodiment illustrated in FIG. 19, the interface view 1900 displays contacts 1904, the number 1906 associated with the communication session, the status of the call, the call duration, and the transcript of the conversation. The interface view 1900 provides various option (e.g., options 302A-N) for communication with another user.

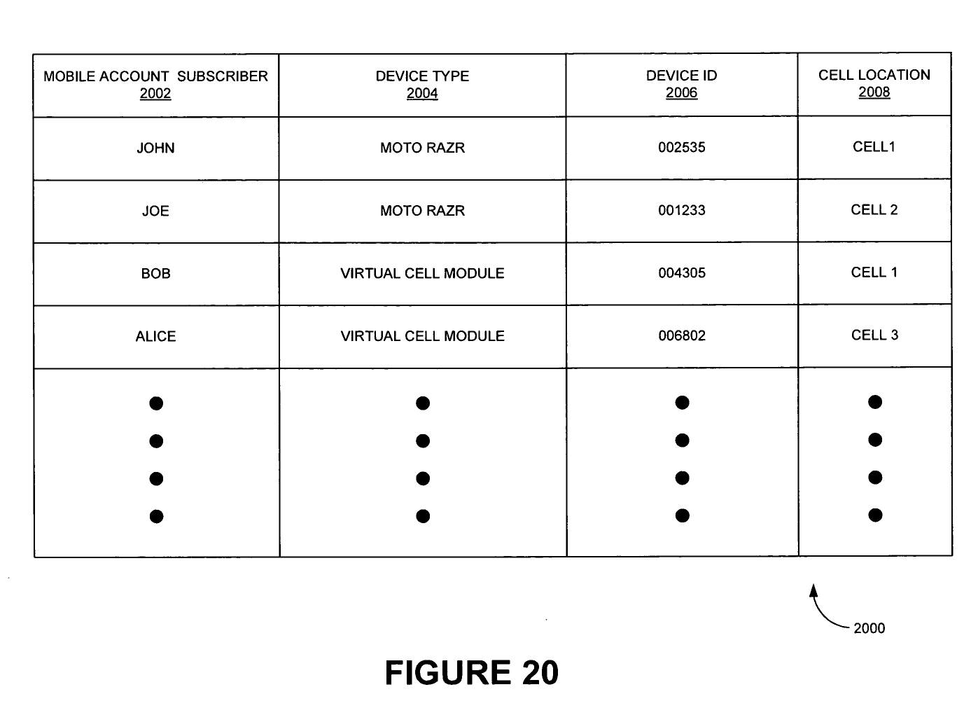

FIG. 20 is a table view of a mobile service provider database 2000, according to one embodiment. Particularly, FIG. 20 illustrates a mobile account subscriber field 2002, a device type field 2004, a device id field 2006 and a cell location field 2008, according to one embodiment. The mobile service provider database 2000 may contain information associated with the mobile account subscriber, device type, device identification number, and location of the cell used by the particular mobile account subscriber.

The mobile account subscriber field 2002 may display an identifier (e.g., a name, a unique key, etc.) of users associated with the mobile device. The device type field 2004 may display information associated with the type of the device used by the particular mobile account subscriber. The device id field 2006 may display the device identification number (e.g., a number assigned to the mobile account by the mobile service provider) associated with the mobile device. The cell location field 2008 may display the location of the cell used by the mobile account subscriber.

In the example embodiment illustrated in FIG. 20, the mobile account subscriber field 2002 displays “John” in the first row, “Joe” in the second row, “Bob” in the third row, and “Alice” in the fourth row of the mobile account subscriber field 2002 column. The device type field 2004 displays “Moto Razr” in the first row, “Moto Razr” in the second row, “Virtual Cell Module” in the third row, and “Virtual Cell Module” in the fourth row of the device type field 2004 column (e.g., mobile account subscribers John and Joe have Moto Razr whereas Bob and Alice have virtual cell module).

The device id field 2006 displays “002535”, the identification number associated with the mobile device of John in the first row, “001233”, the identification number associated with the mobile device of Joe in the second row, “004305”, the identification number associated with the mobile device of Bob in the third row, and “006802”, the identification number associated with the mobile device of Alice in the fourth row of the device id field 2006 column. The cell location field 2008 displays “Cell 1” in the first row, “Cell 2” in the second row, “Cell 1” in the third row, and “Cell 3” in the fourth row in the cell location field 2008 column (e.g., the location of mobile device associated with John and Bob is cell 1, Joe is cell 2, and Alice is cell 3).

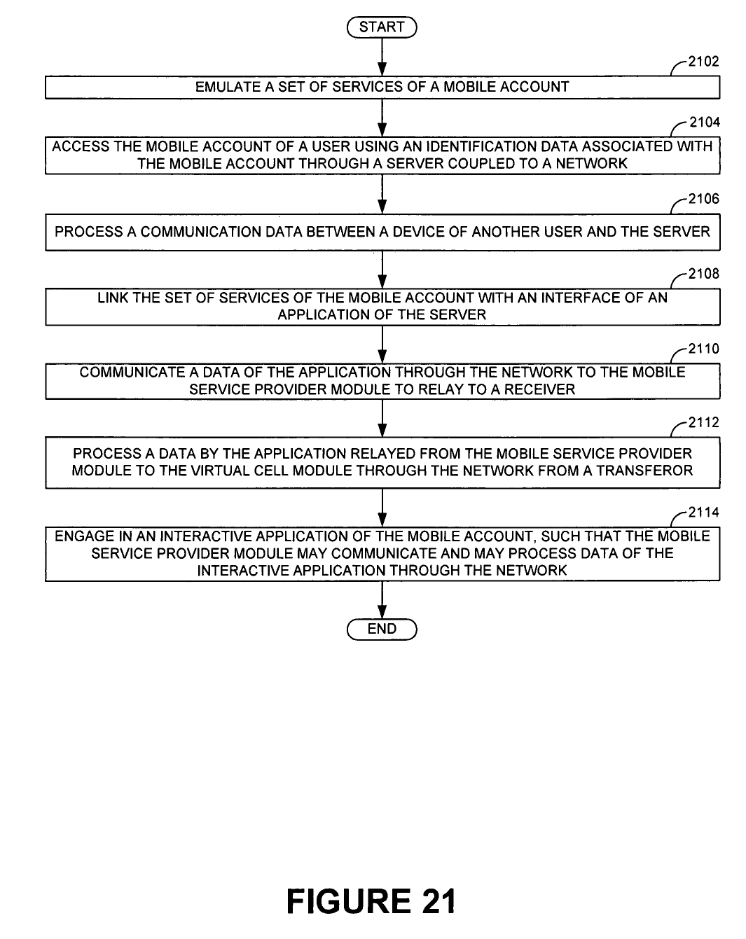

FIG. 21 is a process flow of providing access to a mobile account of a user through a virtual cell module 104, according to one embodiment. In operation 2102, a set of services of a mobile account may be emulated. In operation 2104, the mobile account of a user (e.g., the users 126A-N of FIGS. 1A-B) may be accessed (e.g., through the mobile service provider module 114 of FIGS. 1A-B) using an identification data associated with the mobile account through a personal computer (e.g., the personal computer 102B of FIG. 1B) coupled to a network (e.g., the network 110 of FIGS. 1A-B and 2).

In operation 2106, a communication data may be processed between a device (e.g., the cell devices 118A-N and the telephones 122A-N of the FIGS. 1A-B) of another user and the personal computer 102B. In operation 2108, the set of services of the mobile account may be linked (e.g., using the group of operation modules 208 of FIG. 2) with an interface of an application of the personal computer 102B. In operation 2110, a data of the application may be communicated through the network 110 to a mobile service provider module (e.g., the mobile service provider module 114 of FIGS. 1A-B) to relay to a receiver. In operation 2112, a data may be processed by the application relayed from the mobile service provider module 114 to the virtual cell module 104 through the network 110 from a transferor. In operation 2114, an interactive application of the mobile account may be engaged in, such that the mobile service provider module 114 communicates and/or processes data of the interactive application through the network 110.

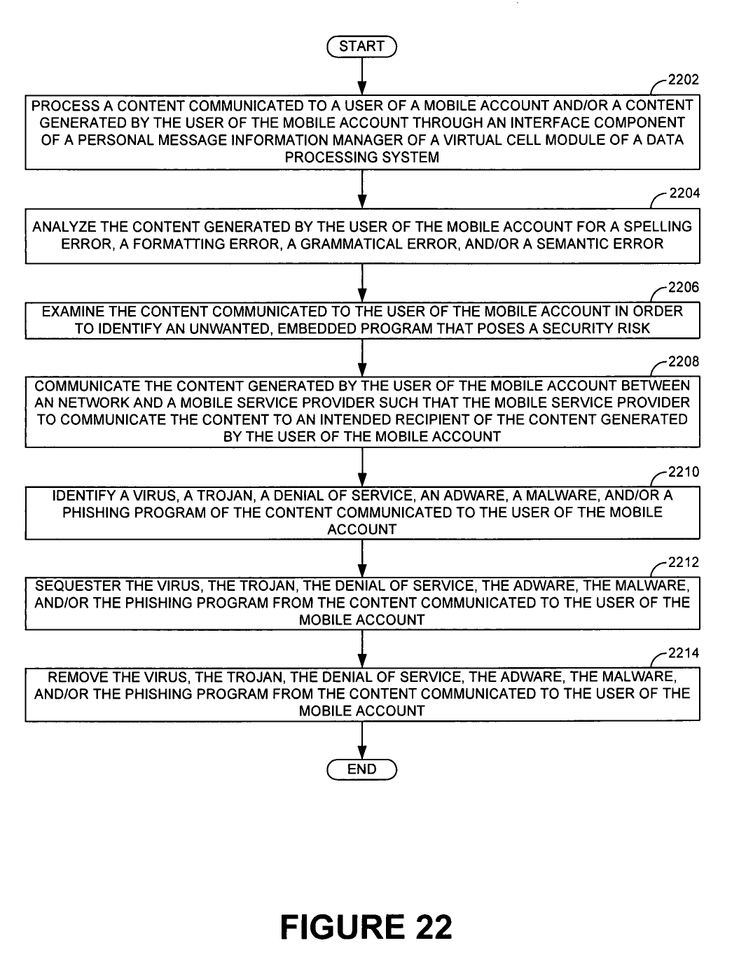

FIG. 22 is a process flow of analyzing and communicating content associated with a user of a mobile account, according to one embodiment. In operation 2202, content communicated to a user (e.g., the users 126A-N of FIGS. 1A-B) of a mobile account and/or content generated by the user (e.g., the users 126A-N of FIGS. 1A-B) of the mobile account may be processed through an interface component of a personal message information manager (e.g., the personal message information manager 1312 of FIGS. 13B-C) of a virtual cell module (e.g., the virtual cell module 104 of FIGS. 1A-B and 2) of a personal computer (e.g., the personal computer 102B of FIG. 1B).

In operation 2204, the content generated by the user (e.g., the users 126A-N of FIGS. 1A-B) of the mobile account may be analyzed for spelling error, formatting error, grammatical error, and/or semantic error. In operation 2206, the content communicated to the user of the mobile account may be examined in order to identify an unwanted, embedded program that poses a security risk.

In operation 2208, the content generated by the user (e.g., the users 126A-N of FIGS. 1A-B) of the mobile account may be communicated between a network (e.g., the network 110 of FIGS. 1A-B and 2) and a mobile service provider such that the mobile service provider communicates the content to an intended recipient of the content generated by the user (e.g., the users 126A-N of FIGS. 1A-B) of the mobile account. In operation 2210, virus, trojan, denial of service, adware, malware, and/or phishing program of the content communicated to the user of the mobile account may be identified (e.g., using the associated application modules 106A-N of FIGS. 1A-B and 2).

In operation 2212, the virus, the trojan, the denial of service, the adware, the malware, and/or the phishing program from the content communicated to the user of the mobile account may be sequestered (e.g., using the associated application modules 106A-N of FIGS. 1A-B and 2). In operation 2214, the virus, the trojan, the denial of service, the adware, the malware, and/or the phishing program may be removed from the content communicated to the user of the mobile account.

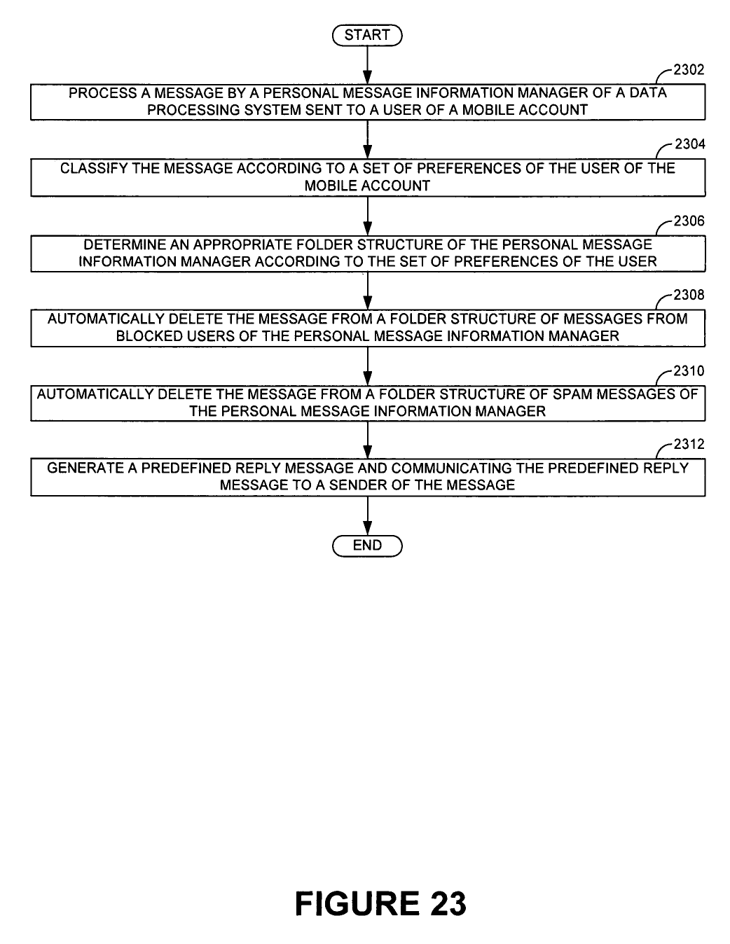

FIG. 23 is a process flow of processing a message by the personal message information manager 1312, according to one embodiment. In operation 2302, a message by a personal message information manager (e.g., the personal message information manager 1312 of FIGS. 13B-C) of a personal computer (e.g., the personal computer 102B of FIG. 1B) sent to a user (e.g., the users 126A-N of FIGS. 1A-B) of a mobile account may be processed. In operation 2304, the message may be classified according to a set of preferences of the user of the mobile account. In operation 2306, an appropriate folder structure of the personal message information manager 1312 may be determined according to the set of preferences of the user.

In operation 2308, the message may be deleted automatically (e.g., through the delete module 226 of FIG. 2) from the folder structure of messages from blocked users of the personal message information manager 1312. In operation 2310, the message may be deleted automatically (e.g., using the delete module 226 of FIG. 2) from a folder structure of SPAM messages of the personal message information manager 1312. In operation 2312, a predefined reply message may be generated (e.g., using the auto-reply module) and communicated to a sender of the message.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). Similarly, the modules disclosed herein may be enabled using software programming techniques.

For example, the virtual cell module 104, the associated application modules 106A-N, the enterprise module 112, the mobile service provider module 114, the input module 200, the synchronization module 204, the incoming module 206, the group of operation modules 208, the communication session module 210, the purchasing module 212, the message module 214, the data transfer module 216, the channel information module 218, the send module 220, the authentication module 224, the delete module 226 and other modules of FIGS. 1-23 may be enabled using a virtual cell circuit, associated application circuits, an enterprise circuit, a mobile service provider circuit, a input circuit, a synchronization circuit, an incoming circuit, an operations circuit, a communication session circuit, a purchasing circuit, a message circuit, a data transfer circuit, a channel information circuit, a send circuit, an authentication circuit, and a delete circuit and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A system comprising:
a server coupled to a network and a plurality of client devices;
a mobile service provider module of a mobile network to provide access to a mobile account, to verify that the mobile account is authorized by a mobile service provider, and to enable usage of services associated with the mobile account; and
a virtual cell module of the server to communicate an identification data of the mobile account to the mobile service provider module to be verified and to provide access to the mobile account through the server.

2. The system of claim 1, further comprising a gateway to bridge communications between the network and the mobile network such that the gateway processes the identification data and communicates the identification data to the mobile service provider module through the mobile network.

3. The system of claim 2, wherein the virtual cell module to communicate voice data between the network and the mobile service provider module, such that the mobile service provider module to route the voice data to an intended recipient.

4. The system of claim 3, wherein the virtual cell module to engage in a communication session to exchange the voice data with a user, such that the mobile service provider module to route the voice data between the virtual cell module and the user.

5. The system of claim 4, wherein the virtual cell module to generate an origination message data and to communicate the origination message data between the network and the mobile service provider module, such that the mobile service provider module to route the origination message data to an intended recipient.

6. The system of claim 5, wherein the virtual cell module to process an incoming message data communicated by the mobile service provider module through the network, such that the mobile service provider module to route the incoming message data to the virtual cell module of the server.

7. The system of claim 6, wherein the virtual cell module to engage in the communication session to exchange message data with another user, such that the mobile service provider module to route the message data between the virtual cell module and the another user.

8. The system of claim 7, wherein the virtual cell module to process a meta-data communicated by the mobile service provider module through the network, such that the mobile service provider module to route the meta-data to the virtual cell module of the server.

9. The system of claim 8, further comprising a purchasing module of the virtual cell module to request and to download multimedia data from a content provider coupled to the mobile service provider module to display on the virtual cell module.

10. The system of claim 9, further comprising a group of operation modules to operate with the virtual cell module to perform a plurality of the services associated with the mobile account.

11. A method comprising:
emulating a set of services of a mobile account;
accessing the mobile account of a user using an identification data associated with the mobile account through a personal computer coupled to a network; and
processing a communication data between a device of another user and the personal computer.

12. The method of claim 11, further comprising linking the set of services of the mobile account with an interface of an application of the personal computer.

13. The method of claim 12, further comprising communicating a data of the application through the network to the mobile service provider module to relay to a receiver.

14. The method of claim 13, further comprising processing the data by the application relayed from the mobile service provider module to a virtual cell module through the network from a transferor.

15. The method of claim 14, further comprising engaging in an interactive application of the mobile account, such that the mobile service provider module to communicate and to process the data of the interactive application through the network.

16. The method of claim 11 in a form of a machine-readable medium embodying a set of instructions that, when executed by a machine, causes the machine to perform the method of claim 11.

17. An apparatus comprising:
a virtual cell module embedded in a data processing system;
a group of operation modules of the virtual cell module, such that each operation module to perform a set of services associated with a mobile account; and
a graphical user interface of the virtual cell module having a number of session windows such that each session window to exchange data with at least one user, a number of input consoles, and the group of operation modules linked to the graphical user interface, wherein a network coupled to the data processing system to securely communicate the data transacted to the mobile account through the data processing system, such that the data processing system and a mobile service provider module communicate with each other using the mobile account.

18. The apparatus of claim 17, further comprising a plurality of applications of the data processing system to link and to interoperate with the group of operation modules of the virtual cell module.

19. The apparatus of claim 18, further comprising a headset apparatus coupled to the data processing system to input a voice data to the graphical user interface of the virtual cell module.

20. The apparatus of claim 19, further comprising a purchasing module to communicate an order of at least one of a media content and a mobile service associated with the mobile account to the mobile service provider, such that the at least one of a media content and a mobile service to be provided to the virtual cell module of a user of the mobile account and be debited from the mobile account.

21. An apparatus comprising:
a virtual cell module embedded in a personal computer; and
a personal message information manager of the virtual cell module to download from a mobile service provider at least one message disseminating from a mobile account.

22. The apparatus of claim 21 further comprising a number of folder structures of the personal message information manager to organize the at least one message based on a classification of the at least one message and to archive the at least one message in order to later refer to the at least one message of the mobile account.

23. The apparatus of claim 22, further comprising a set of preferences to enable classification and organization of the at least one message into any of the number of folder structures.

24. The apparatus of claim 23, wherein the at least one message is at least one of a text message, a SMS message, a video message, an audio message, and a multimedia message.

25. The apparatus of claim 24, further comprising an auto-reply module of the personal message information manager to generate and to communicate a preset message to a sender of any one of the at least one message.

26. The apparatus of claim 25, further comprising an interface component of the personal message information manager to process an input of a user of the mobile account.

27. The apparatus of claim 26, wherein the input is at least one of a textual input, an audio input, a video input, and a multimedia input

28. The apparatus of claim 27, wherein the interface component to analyze a content of the input of the user of the mobile account and to identify a potential error of the input.

29. The apparatus of claim 28, wherein the interface component to suggest a modification of the content of the input based on the potential error identified through an analysis of the content of the input.

30. The apparatus of claim 29, wherein the modification is at least one of a spelling change, a grammatical change, a semantic change, and a formatting change.

31. The apparatus of claim 30, further comprising an integrity component of the personal message information manager to examine the content of the input and to identify at least one of a virus, a trojan, a phishing activity, a denial of service, a worm, an adware, a malware, a spyware, and a spam.

32. The apparatus of claim 31, wherein the integrity component to quarantine and to remove the at least one of a virus, a trojan, a phishing activity, a denial of service, a worm, a adware, a malware, a spyware, and a spam from the content of the input.

33. The apparatus of claim 32, wherein the integrity component is at least one of an antivirus application, an anti-spam application, an anti-spyware application, and an anti-phishing application.

34. The apparatus of claim 33, further comprising a send module to communicate the input between a network and a mobile service provider such that the mobile service provider to route the content to an intended recipient.

35. The apparatus of claim 34, further comprising a delete module of the personal message information manager to remove any one of the at least one message.

36. The apparatus of claim 35, further comprising a purchasing module of the personal message information manager to communicate an order of media content and mobile services to the mobile service provider to be provided to a mobile device of the user of the mobile account.

37. The apparatus of claim 36, further comprising a synchronization module of the personal message information manager to update and to harmonize an information of the user associated with the mobile device of the mobile account with the personal message information manager.

38. A method comprising:
processing at least one of a content communicated to a user of a mobile account and a content generated by the user of the mobile account through an interface component of a personal message information manager of a virtual cell module of a personal computer;
analyzing the content generated by the user of the mobile account for at least one of a spelling error, a formatting error, a grammatical error, and a semantic error;
examining the content communicated to the user of the mobile account in order to identify an unwanted, embedded program that poses a security risk; and
communicating the content generated by the user of the mobile account between a network and a mobile service provider such that the mobile service provider to communicate the content to an intended recipient of the content generated by the user of the mobile account.

39. The method of claim 38, further comprising identifying at least one of a virus, a trojan, a denial of service, an adware, a malware, and a phishing program of the content communicated to the user of the mobile account.

40. The method of claim 39, further comprising sequestering the at least one of a virus, a trojan, a denial of service, a adware, a malware, and a phishing program from the content communicated to the user of the mobile account.

41. The method of claim 40, further comprising removing the at least one of a virus, a trojan, a denial of service, a adware, a malware, and a phishing program from the content communicated to the user of the mobile account.

42. The method of claim 38 in a form of a machine-readable medium embodying a set of instructions that, when executed by a machine, causes the machine to perform the method of claim 38.

43. A method comprising:
processing a message by a personal message information manager of a personal computer sent to a user of a mobile account;
classifying the message according to a set of preferences of the user of the mobile account; and
determining an appropriate folder structure of the personal message information manager according to the set of preferences of the user.

44. The method of claim 43, further comprising automatically deleting the message from a folder structure of messages from blocked users of the personal message information manager.

45. The method of claim 44, further comprising automatically deleting the message from the folder structure of SPAM messages of the personal message information manager.

46. The method of claim 45, further comprising generating a predefined reply message and communicating the predefined reply message to a sender of the message.

47. The method of claim 43 in a form of a machine-readable medium embodying a set of instructions that, when executed by a machine, causes the machine to perform the method of claim 43.
